(19) United States
(12) Patent Application Publication
(10) Pub. No.: US 2007/0011334 A1
(43) Pub. Date: Jan. 11, 2007

(54) Methods and apparatuses to provide composite applications

(76) Inventors: Steven Higgins, Glen Mills, PA (US); Jim Collins, Barrington Hills, IL (US); Peter Clare, Tiburon, CA (US); Stewart A. Skomra, Poway, CA (US)

Correspondence Address: GREENBERG TRAURIG, LLP, 1900 UNIVERSITY AVENUE, FIFTH FLOOR, EAST PALO ALTO, CA, 94303, US

(21) Appl. No.: 11/387,245

(22) Filed: Mar. 22, 2006

Related U.S. Application Data
(63) Continuation-in-part of application No. 10/947,566, filed on Sep. 22, 2004.
(60) Provisional application No. 60/517,114, filed on Nov. 3, 2003.
(60) Provisional application No. 60/579,379, filed on Jun. 12, 2004.
(60) Provisional application No. 60/698,676, filed on Jul. 12, 2005.
(60) Provisional application No. 60/737,579, filed on Nov. 16, 2005.

(51) Int. Cl. G06F 15/16

(52) U.S. Cl. 709/227

(57) ABSTRACT

Methods and apparatuses to enable the development, deployment and update of composite applications on mobile devices. In one embodiment, a method processor in a mobile device may include a workflow engine and a cache manager which looks ahead of the current execution of a workflow to preload modules. The method processor may present modal user interfaces in a non-modal way to eliminate flicker, and use a logger to stamp the workflow related data with real time measurements, such as time, location, and vehicle bus information. The logger may capture screen images and global data of the workflow during the execution. The log data stream may be collected and sent from the mobile device in real time, or in a batch mode, for monitoring, debugging, diagnosing or tuning the execution of a workflow, for providing hot update, help and guidance against deviation during the execution, and for other features.

The present patent application is a continuation in part application of: co-pending U.S. patent application Ser. No. 10/947,566, filed on Sep. 22, 2004 and claimed the priority from Provisional U.S. Patent Application Ser. No. 60/517,114 filed on Nov. 3, 2003 and the priority from Provisional U.S. Patent Application Ser. No. 60/579,379 filed on Jun. 12, 2004. The present patent application claims the priority from Provisional U.S. Patent Application Ser. No. 60/698,676, filed Jul. 12, 2005 and the priority from Provisional U.S. Patent Application Ser. No. 60/737,579, filed Nov. 16, 2005. These prior applications are hereby incorporated herein by reference.

### TECHNOLOGY FIELD

At least some embodiments of the present invention relate to computing systems and, more particularly to systems involving mobile computing with flexible architecture for application development, deployment and customization.

### BACKGROUND

Traditionally, an application program for mobile platforms is developed and deployed as one monolithic program with highly inter-dependent parts optimized for performance on a specific hardware platform.

It is very difficult to adapt such monolithic programs to meet the different needs of different users. Since parts of these monolithic programs are highly inter-dependent, a small change in one part of an application program may lead to a chain of changes in many other parts of the application program. Thus, such monolithic programs are typically specially designed and developed only for a specific customer with very high cost and very limited functionality.

Further, when such a monolithic program is to be updated to fix bugs or add functionality, the entire monolithic program is to be re-loaded to the mobile device. Since the size of the entire monolithic program is large, updating mobile devices with such monolithic programs can require very high bandwidth. Thus, Over-the-Air (OTA) updating of such monolithic programs for a large population of mobile devices can be very difficult, if not impossible.

Further, since the monolithic programs are specifically designed for specific customers by different vendors, it is very difficult, if not impossible, for the customers to re-arrange the programs to meet the changing needs of the customers. Typically, source code level access is required to reuse the components of the monolithic programs. However, software vendors are typically reluctant to reveal the source code of the monolithic programs. Thus, it would be a very difficult task for the customers to combine certain features of the monolithic programs to make a new composite application.

In general, many application programs are designed for a more or less specified targeted environment, a platform, which may be identified by a particular configuration of hardware and/or software. A platform may be based substantially on software, called a virtual machine.

A virtual machine may be a virtual machine emulator, which includes a software program that emulates a hardware system.

A virtual machine may be a virtual machine environment, which includes an operating system running in a virtualized computer. A virtual machine monitor can be used between the hardware and the operating system such that two or more instances of the same operating system, or two or more different operating systems, can run together on the same hardware. From a user perspective, these multiple operation system instances run in the virtualized computer simultaneously or concurrently, as if the virtualized computer were equivalent to a virtual set of multiple computers each running a separate one of the multiple operating system instants, although the operating system instances actually share the same hardware in time. Each operating system instance on the virtualized computer runs its own applications as if the operating system were running on the hardware alone.

An operating system is typically the master software, which controls the hardware of a specific data-processing system, provides a set of interfaces for application programs to access the hardware, and provides functions in a number of common areas, such as user interface, memory management, device management, security, process/job management, etc. Thus, an operating system may be considered as a virtual machine.

An operating system may be called an “executive” or “supervisor.” A virtual machine monitor may be called a “hypervisor.”

A virtual machine may be a virtual machine interpreter, which includes an interpreter for a programming language. A virtual machine interpreter typically runs an application program in an interpretive mode, or in a just-in-time (JIT) compilation mode.

The executable environment in which a program runs can be called the runtime environment, which typically includes the hardware, operating system and other system programs (database, network, etc.). Typically, application programs running in an operating system call upon routines in the operating system to perform input/output, graphical interface and other functions. An application running in a virtual machine interpreter calls upon runtime software in execution. Runtime software of a virtual machine interpreter implemented on a specific operating system provides interpretation services between the application program and the operating system.

For example, Java application programs typically use the Java Virtual Machine runtime environment for execution. The runtime software may interpret the programming language one line at a time and use library routines to implement the instructions of the application program, or compile the entire application program to a set of native instructions of the computer just in time before execution.

An application program written in the Java programming language can be compiled into an intermediate programming language called Java byte code, which may be executed in a number of different ways. For example, in an interpretative mode, Java byte code can be interpreted one line at a time by a Java virtual machine for conversion into a native programming language of a processor for execution. Alternatively, in a just-in-time compilation mode, the entire application program in the Java byte code can be compiled by a just-in-time compiler into the native programming language of the processor, just before the execution of the application program. Alternatively, the application program in the Java programming language may be compiled and optimized directly into the native programming language for execution on the processor. Alternatively, a processor designed with native support for the Java byte code can execute the application program in Java byte code without further software compilation or interpretation.

In general, different programming languages may be compiled into a same intermediate programming language for execution by a virtual machine interpreter. For example, different .NET programming languages, including C# and VB.NET, can be compiled into the Microsoft Intermediate Language (MSIL), which is typically executed by the Common Language Runtime (CLR) software in a computer running an operating system from Microsoft. Microsoft's .NET platform uses the Common Language Runtime (CLR) to compile .NET applications into the native machine language for execution. A subset of the Common Language Runtime (CLR) has been standardized by European Computer Manufacturers Association (ECMA).

Java virtual machine can be implemented in a variety of environments, such as web browser, web server, desktop, etc. A Java program that runs in a web page rendered in a web browser can be called a Java applet. A Java program that runs on a server to assist a web server can be called a Java servlet.

Java 2 Platform, Micro Edition (J2ME) is a version of Java designed for cell phones, Personal Digital Assistances (PDAs) and consumer appliances. J2ME uses a Java interpreter specialized for devices with limited memory. J2ME includes different Java profiles, which can be implemented by different J2ME devices. For example, the Mobile Information Device Profile (MIDP) is designed for mobile devices, such as cell phones, with support for a graphical interface, networking and storage; and the Personal Profile is designed for consumer products and embedded devices, such as Set-top boxes and PDAs. Java profiles are based on Java configurations, such as the Connected Limited Device Configuration (CLDC) designed as the strict subset of Java class library and the minimal environment for a Java virtual machine.

Binary Runtime Environment for Wireless (BREW) is an application development environment for enhanced cell phone services (e-mail, games, etc.). BREW applications run on a BREW-enabled cell phone handset independent of the underlying system software of the handset. A software development tool for BREW can compile applications developed for the BREW platform from a number of different programming languages, such as C/C++, into a native programming language of the processor of a BREW-enabled cell phone handset.

On a BREW-enabled device, Java virtual machine can be implemented as an extension to BREW. A Java extension can be installed on top of BREW to allow the execution of Java byte code on a BREW platform. When the Java virtual machine is implemented as an extension to BREW, the implementation can be actually smaller than a Java virtual machine implemented natively and directly on the system software of cellular phones, since an optimized BREW-extension for Java virtual machine can use the existing phone-specific application programming interfaces (APIs) provided by BREW.

In a networked environment, a client computer that requests services may communicate with a server that provides the services through a variety of communication channels.

For example, HyperText Transfer Protocol (HTTP) can be used to request and receive files (e.g., web pages) over a computer network, such as the Internet.

For example, remote procedure call allows one program running in one machine to use the services of another program in a remote machine. Using a set of library routines, a calling program can send a message and data to the remote program, which after being executed can pass the result back to the calling program. Library routines for remote procedure call are designed to carry out the networking details for the communication.

Email provides a way to transmit messages electronically and reliably over a computer network. In an email system, messages may be queued on a sending computer, waiting for a scheduled time slot to upload or transmit the messages, or waiting for the network connection to a receiving computer to become available; on the receiving computer, the messages are typically queued, waiting for the user to process. In certain systems, filter programs may be used to automatically process some incoming messages according to pre-defined rules. Email systems typically support the transmission of electronic messages of a variety of formats, such as plain text, executable code, image files, sound clips, web pages, etc.

Instant messaging uses a real time connection to transmit messages. When the real time connection is broken, messages may be lost. For real time delivery, instant messages are not queued.

### SUMMARY OF THE DESCRIPTION

Methods and apparatuses to enable the development, deployment and update of composite applications on mobile devices are described herein. Some but not all embodiments of the present invention are summarized in this section.

In one embodiment, a method processor in a mobile device may include a workflow engine and a cache manager which looks ahead of the current execution of a workflow to preload modules. The method processor may present modal user interfaces in a non-modal way to eliminate flicker, and use a logger to stamp the workflow related data with real time measurements, such as time, location, and vehicle bus information. The logger may capture screen images and global data of the workflow during the execution. The log data stream may be collected and sent from the mobile device in real time, or in a batch mode, for monitoring, debugging, diagnosing or tuning the execution of a workflow, for providing hot update, help and guidance against deviation during the execution, and for other features.

The present invention includes methods and apparatuses which perform methods as described, including data processing systems which perform these methods, and computer readable media which when executed on data processing systems cause the systems to perform these methods.

Other features of the present invention will be apparent from the accompanying drawings and from the detailed description which follows.

### BRIEF DESCRIPTION OF THE DRAWINGS

The present invention is illustrated by way of example and not limitation in the figures of the accompanying drawings, in which like references indicate similar elements.

FIG. 1 illustrates a system with an integration server to connect mobile devices and an authoritative data source.

FIG. 2 shows an architecture structure of a mobile device.

FIG. 3 illustrates a visual representation of a workflow.

FIG. 4 illustrates a way to construct a workflow method.

FIG. 5 illustrates a software architecture structure for providing composite applications.

FIG. 6 illustrates a way to build a composite application.

FIG. 7 shows a process at an integration server to provide data connection between mobile devices and an authoritative data source.

FIG. 8 shows a flow diagram of a process to render user interfaces for sequential display.

FIG. 9 shows a flow diagram of another process to render user interfaces for sequential display.

FIG. 10 shows a flow diagram of a process to selectively pre-construct forms.

FIG. 11 illustrates a way to obtain log data.

FIG. 12 shows a flow diagram of a process to log screen images of user interfaces by a method processor.

FIG. 13 shows a flow diagram of a process to improve workflows using log data.

FIG. 14 shows a flow diagram of another process to improve workflows using log data.

FIG. 15 illustrates an integrated development environment with a self documenting feature.

FIG. 16 shows a flow diagram of a process to utilize patterns in a stream of log data to provide a monitoring feature.

FIG. 17 shows a flow diagram of a process to replay an execution of a workflow.

FIG. 18 shows a flow diagram of a process to display an execution of a workflow with a time shifting feature.

FIG. 19 shows a flow diagram of a process to monitor deviation from a reference execution of a workflow.

FIG. 20 shows a flow diagram of a process to perform prediction and optimization based on monitoring an execution of a workflow.

### DETAILED DESCRIPTION

The following description and drawings are illustrative of the invention and are not to be construed as limiting the invention. Numerous specific details are described to provide a thorough understanding of the present invention. However, in certain instances, well known or conventional details are not described in order to avoid obscuring the description. References to one or an embodiment in the present disclosure can be, but not necessarily are, references to the same embodiment; and, such references mean at least one. Various features described in the present disclosure may be in some embodiments but not in others.

Mobile Environment

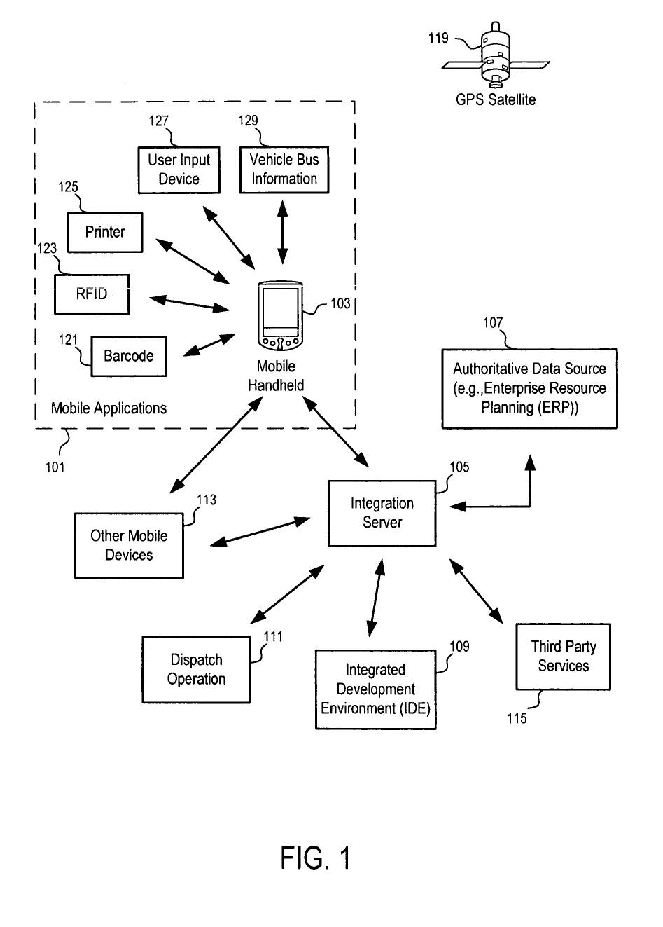

FIG. 1 illustrates a system with an integration server to connect mobile devices and an authoritative data source.

In one embodiment of the present invention, a mobile device (e.g., 103) can be used for a variety of different mobile applications (101), such as accessing barcode (121), radio frequency identification (RFID) (123), printer (124), user input device (127, such as scanner), vehicle bus information (129), etc.

The mobile handheld (103) may include a Global Positioning System (GPS) receiver to determine the location of the mobile handheld (103) and provide location-dependent services. The mobile handheld (103) may automatically determine its position and record various information in association with the determined position and time. Alternatively, or in combination, the mobile handheld (103) may use other positioning systems to determine its location, such as a cellular positioning system, a hybrid positioning system which uses both satellite positioning system signals and cellular positioning system signals, or other types of satellite positioning system, such as the GLObal NAvigation Satellite System (GLONASS) in Russia and proposed Galileo positioning system in Europe.

In FIG. 1, an integration server (105) is used between an authoritative data source (107) and mobile devices (e.g., 103, 113) to facilitate data access and integration. For example, the integration server (105) may retrieve the data that is being requested by the mobile device (103) and cache the data for access by other mobile devices (113). When changes to the data are checked in from the mobile devices, the integration server (105) can detect and resolve any conflict and store a consistent version of the changed data back to the authoritative data source (107). Thus, the integration server implements the logic to maintain data integrity and consistency while providing data access to multiple mobile devices which may use unreliable, sometime unavailable, slow network connections for data communication.

One example of an authoritative data source is Enterprise Resource Planning (ERP), which is an integrated information system that serves various aspects of an enterprise organization, such as manufacturing, order entry, accounts receivable and payable, general ledger, purchasing, warehousing, transportation and human resources, etc. The data may be under control of a database manager which provides data service using a Structured Query Language (SQL). The data may be stored in a flat file, or a directory tree of a file system.

The integration server (105) may be capable to access multiple different data sources and provide a uniform interface for the mobile devices to access authoritative data. Thus, the integration server (105) shields the mobile devices (and mobile applications) from the detailed implementation of the authoritative data.

The integration server (105) may be used to distribute applications and updates to the mobile devices. For example, new business processes can be developed using an integrated development environment (109) and distributed to the mobile devices (e.g., 103 or 113) for execution through the integration server (105).

In one embodiment of the present invention, a novel architecture of the mobile applications allows the mobile applications to be developed quickly, modified, tested, and deployed easily to mobile devices over-the-air (OTA). The mobile applications may be developed as composite applications that use components of existing applications. The novel architecture includes a workflow engine based method processor, which may be implemented on a virtual machine interpreter for a programming language (e.g., Java byte code or Microsoft Intermediate Language, Python, or other programming language). The method processor loads task modules in the programming language for execution by the virtual machine interpreter. The method processor loads task modules according to a description of a workflow (e.g., in an extensible markup language (XML), or other markup languages, or a custom format) which is interpreted by the method processor. The method processor may load modal user interface forms in a non-modal way to prevent flickers and to improve user friendliness. The method processor may include a hardware abstraction layer to encapsulate the implementation details of various types of peripheral devices from the mobile applications.

In FIG. 1, dispatch operations (111) can be in the form of sending, through the integration server (105), workflow applications that embodies business logic. The actual components of the execution codes are typically preloaded in the mobile devices and transmitted over-the-air when needed. The workflows can be easily modified, updated and dispatched to the mobile devices, even during the execution of the workflows.

Further, the integration server may provide to mobile devices the access to third party services (115), such as services provided through third party web sites. For example, the mobile handheld (103) may request the integration server to perform a task which requires resources from the third party services (115).

In the present description, various mobile platforms include cell phones, PDAs, handheld computers, notebook computers, etc. For example, mobile devices can be suitable for being held in one hand of a human user. Mobile devices may have one or more wireless communication capabilities, such as Bluetooth (e.g., in accordance with IEEE 802.15), WiFi (e.g., in accordance with IEEE 802.11), WiMax (e.g., in accordance with IEEE 802.16), cellular data communication access, etc. Mobile devices can have wired connections to the network at certain locations, such as when being placed in a cradle or being connected to a network access port via a cable.

In general, the physical communication channels between the mobile devices (e.g., 103, 113) and the servers (e.g., 105) may not be secure. The data communication can be secured through encryption. For example, a virtual private network can be configured within a public network (e.g., Internet) to provide a secure data communication environment for the mobile application system. For example, digital certificates can be used to identify the devices and systems such that the devices and systems are in a trusted group, in which application programs can be safely transmitted from one to another for execution.

Further, a communication layer can be configured to apply data compression schemes to reduce the data transmission time. For example, data compression can be selectively applied, just-in-time (or, on-the-fly) based on the type of data content. Data records retrieved from the authoritative source are compressed to reduce the time period for data transmission. For example, the communication layer can automatically determine whether components of a data package have already been cached (stored) to avoid receiving the cached components once again over the network connection.

In one embodiment of the present invention, the communication layer performs a cost-benefit analysis to determine when and which communication channel is to be used for transmitting what data. For example, various communication channels (e.g., Bluetooth, WiFi, WiMax, cellular phone communications, local area network, etc.) can be assigned different cost indicators. Various different types of data can be assigned different benefit (priority) indicators. The availability of different communication channels can be determined/estimated (e.g., based on statistical data collected through a period of operations and/or tests). The time delay to when a network channel may become available can have a corresponding cost indicator. The mobile devices may automatically collect statistical data (heuristics) about the time and date when the communication connections and network resources are available and the location where the communication connections and network resources are available. The statistical data are used to determine the availability of communication connections and network resources. The communication layer performs a cost-benefit analysis to schedule specific data for delivery over a specific network channel at specific time range. Thus, the transmission of data and access to network resources can be scheduled to reduce cost and increase system performance.

Optionally, the cost/benefit indicators can be adjusted to optimize or customize the system for specific needs.

In FIG. 1, the integration server (105) is implemented on a data processing system separate from one or more data processing systems for the dispatch operations, integrated development environment (IDE) and/or authoritative data source. Alternatively, the integration server (105) may be implemented on a data processing system which also performs other operations, such as dispatch operations, integrated development environment (IDE) and/or authoritative data source, etc.

In general, a mobile device, or a server system, is implemented as a data processing system, which includes memory and at least one processor.

A processor can be a general-purpose microprocessor used as a Central Processing Unit (CPU), an Application Specific Integrate Circuit (ASIC) which is custom designed for a specific application, or a Field Programmable Gate Array (FPGA). In some implementations, a processor may include memory to store embedded software in a configuration called “system on a chip” (SoC). In some implementations, a data processing system may include multiple CPUs (e.g., for a server system).

Typically, a data processing system includes an inter-connect (e.g., bus, system core logic, etc.), which interconnects a processor and memory which is used to store instructions for execution by the processor and related data.

Typically, the inter-connect further connects the processor and memory to other components, such as a display controller and display device, peripheral devices such as input/output (I/O) devices controller(s) to control I/O devices, such as mice, keyboards, modems, network interfaces, printers, scanners, video cameras, GPS receiver, and/or other devices.

The inter-connect may include one or more buses connected to one another through various bridges, controllers and/or adapters, such as USB (Universal Serial Bus) port, IEEE-1394 bus adapter, etc.

The memory may include ROM (Read Only Memory), and volatile RAM (Random Access Memory) and other non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, or an optical drive (e.g., a DVD RAM), or other type of memory system which maintains data even after power is removed from the system, such as flash memory. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

A data processing system may have more or less components, dependent on the configuration and usage. For example, a server data processing system may not include certain components, such as display, keyboard, etc. A mobile device may include an integrated display (e.g., a liquid-crystal display (LCD) panel). The display may have the capability to receive input (e.g., a touch screen panel). Further, a mobile device may include the circuitry for telephonic communications, such as a two-way radio subsystem for cellular communication.

The above description of a data processing system is not intended to represent any particular architecture or manner of interconnecting the components. In general, other systems that have fewer or more components may also be used with the present invention.

In general, the routines executed to implement the embodiments of the invention may be implemented as part of an operating system or a specific application, component, program, object, module or sequence of instructions referred to as “programs.” An application program typically includes one or more instructions set at various times in various memory and storage devices in a computer, and that, when read and executed by one or more processors in a computer, cause the computer to perform operations necessary to execute elements involving the various aspects of the invention. An application program is typically tangibly stored on a machine/computer-readable media.

A machine readable medium can be used to store software and data which when executed by a data processing system causes the system to perform various methods of the present invention. The executable software and data may be stored in various places including for example ROM, volatile RAM, non-volatile memory and/or cache. Portions of this software and/or data may be stored in any one of these storage devices.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media, such as Compact Disk Read-Only Memory (CD ROMS), Digital Versatile Disks, (DVDs), etc. An application program can also be embodied in digital and analog communication links as electrical, optical, acoustical or other forms of propagated signals, such as carrier waves, infrared signals, digital signals, etc.

In general, a machine readable medium includes any mechanism that provides (e.g., stores and/or transmits) information in a form accessible by a machine (e.g., a computer, network device, personal digital assistant, manufacturing tool, any device with a set of one or more processors, etc.).

Aspects of the present invention may be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

In various embodiments, hardwired circuitry may be used in combination with software instructions to implement the present invention. Thus, the techniques are not limited to any specific combination of hardware circuitry and software, nor to any particular source for the instructions executed by the data processing system.

In this description, various functions and operations are described as being performed by or caused by software code to simplify description. However, those skilled in the art will recognize what is meant by such expressions is that the functions result from execution of the code by a processor, such as a microprocessor.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the operations could be implemented in hardware, firmware, software or any combination thereof.

Architecture

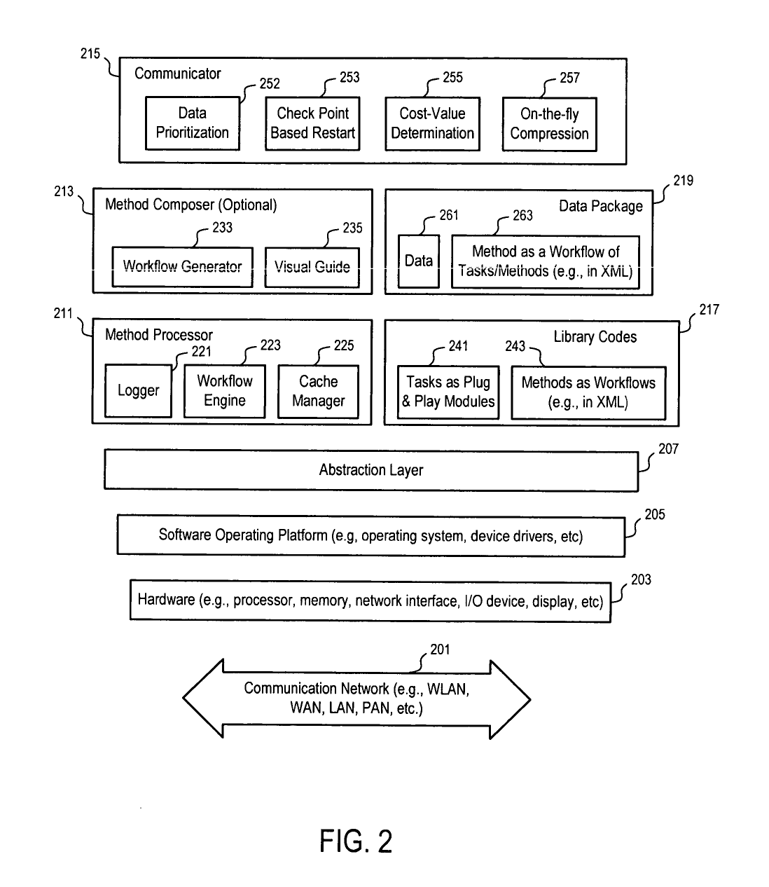

FIG. 2 shows an architecture structure of a mobile device. In FIG. 2, a mobile device is designed to perform some operations locally using the hardware (203), which may include processor, memory, network interface, I/O device, display, etc., and some other operations via a communication network, such as one or more of Wireless Local Area Network (WLAN), Personal Area Network (PAN), Wide Area Network (WAN), Local Area Network (LAN), etc., or a combination of networks, such as the Internet.

In FIG. 2, the mobile device has a software operating platform, which may include an operating system, device drivers, etc. The software operating platform controls the low level operations of the hardware (203) and provides a conventional environment for the application programs. For example, the software operating platform may include the BREW platform, an operating system from mobile devices, a Java runtime environment, and/or a Common Language Runtime environment, etc.

In one embodiment of the present invention, a method processor (211) is developed on the software operating platform (205) for execution on the hardware (203). An abstraction layer (207) is used to encapsulate the differences between different implementations of various types of peripheral devices, such as printer, scanner, radio controller, etc. The abstraction layer for the method processor (211) allows the program modules for the method processor to be developed in a way independent of the implementation details of devices of the same type.

In FIG. 2, the method processor (211) includes a workflow engine (223), a cache manager (225) and a logger (221).

The workflow engine (223) and the cache manager (225) may run in different threads while communicating with each other to pre-load and cache task modules in a programming language (e.g., Java byte code) for execution.

The workflow engine (223) parses a definition of a workflow and loads corresponding modules of the workflow for execution. The task modules in the programming language (e.g., Java byte code) can be loaded into the same process and the same thread of the workflow engine (223).

A unit of a workflow can be defined in a method file (e.g., as an application and/or as a module), which specifies the data connections between the modules in the workflow and the execution paths among the modules. The workflow engine causes the modules that are specified in the method file to be executed one after another, in accordance with the outcomes of modules and the direction of flow specified in the method file.

In general, a method file can be designed as a standalone application and/or a module which can be used in another method file. When the workflow defined in a method file is used as a module in another method file, the method file can be considered as a method module. The workflow defined in the method module can be considered a sub-workflow of the application. A method module may be referred to as a workflow method module, or a sub-workflow method, or a workflow method, or a sub-method. Some method files can be used both as standalone applications or as modules in other applications.

The logger (221) is coupled with the workflow engine (223) to collect data related to the execution of a workflow. The logger (221) may run in the same thread as the workflow engine (223) or in a separate thread.

The logger (221) may be designed to have access to real time sensor data about the location, time and environment of the mobile device, such as the location of the mobile device, date and time of any event occurred on the mobile device, temperature, vehicle bus information (e.g., vehicle speed, amount of remaining fuel), etc. Such sensor data are obtained and recorded before and/or after the execution of a module of the workflow. Thus, the logger (221) can automatically collect such sensor data in connection with the execution of the workflow, such that the circumstances of the execution of the workflow can be recorded for further analysis, which can be used for various improvements. The logger (221) can also automatically collect execution data in response to events related to sensors, such as when a measurement reaches a threshold, when a type of sensor data becomes available (e.g., through a network connection), etc.

Further, the logger (221) can be coupled to the workflow engine to record the data that flows into and/or out of the modules of the executed workflow, in connection with the sensor data. Thus, the circumstances of the data flows can be recorded for further analysis.

The logger (221) may record at least a portion of the sensor data in response to events generated by the workflow engine (223). For example, the workflow engine (223) generates events in response to entering or exiting a module of a workflow. The logger (221) associates the sensor data (e.g., time, location, temperature, phone data, camera data, network input, etc.) with the event data supplied from the workflow engine (223), which may include the identification of the module, data to be supplied to the module or copied from the module, the status of the workflow engine (e.g., memory state, etc.), screen images, and others.

The cache manager (225) is coupled to the workflow engine (223) to improve the performance of the execution of a workflow. The method processor (211) can automatically cache frequently executed modules and perform look-ahead analysis in combination with past execution history to predict what module might be needed next and to pre-load the execution code for the module into memory. When the past execution history on the mobile device is not available, the statistic data based on execution on one or more other mobile devices can be used. When no real world execution history is available (or when no sufficient real world execution history is available), pre-designed parameters, such as weighting factors which may be determined based on the knowledge of the designer or based on speculation, can be used to perform look-ahead analysis. The pre-designed weighting factors may be weighted against the available execution history such that, when sufficient execution history is available, the look-ahead analysis is mainly (or entirely) based on the past execution history.

For example, during the time period in which the processor is not fully busy, such as when a user interface form is displayed to the user for user interaction, the method processor may look ahead of the current task in the workflow and determine the modules that are likely to be executed after the current module, according to statistics of past results generated from the current module. The method processor can then load the modules into memory in anticipation of the flow to the subsequent modules. The cache manager (225) keeps in memory the modules that are likely to be used and purges other modules out of the memory.

Further, the method processor may pre-load and execute a portion of a user interface module without mapping the user interface form to the display. Thus, when the user interface form is needed, the time to display the user interface form is reduced, since the user interface form has been pre-rendered and cached.

When the execution of a user interface module is completed, the method processor may not immediately destroy the user interface form (or a portion of the form). Instead, the user interface form as rendered may be cached and re-initialized when needed. Such caching operations can improve the responsiveness of the mobile device and provide better user experience.

A module of a workflow can be a set of instructions in a programming language to be executed through the interpretation via the software operating platform (205), or a set of instructions in a programming language executable directly by the hardware (203). A module can be provided as a shared library, which can be dynamically loaded into the method processor for execution and/or dynamically unloaded. A shared library includes a unit of instructions in a programming language that can be dynamically loaded into a running application program that is in the same programming language, so that the instructions dynamically becomes part of the running application program. Example formats of shared libraries include a dynamic link library (dll) file, a Java archive (jar) file, etc.

A module of a workflow can also be a method file which describes a sub-workflow. Such a method file may be called a sub-method file, in the context in which it is used as a module. In general, any method file may later be used in other method files as a sub-workflow and thus be called a sub-method file.

In FIG. 2, the mobile device includes a set of library codes (217), which may include tasks (241) as plug & play modules of instructions which are in one or more programming languages executed on the software operating platform (205) and/or the hardware (203). The library codes (217) may further include methods as workflows (243) (e.g., in XML), to be processed by the workflow engine (223). The methods as workflows (243) are method modules which may call upon task modules (e.g., 241) to perform operations.

An application can be provided as a data package (219), which includes input data (261) and a method as a workflow of tasks/methods (sub-methods). The data package (workflow application) is processed for execution by the method processor which includes the workflow engine. Since the data package (219) contains the input data and the definition of the workflow but typically not the detailed instructions to perform the tasks (which are typically in the mobile device as library codes (217)), the data package (219) can be quickly dispatched to the mobile device for execution, even when dispatched over-the-air. When needed, a portion of the library codes (217) that is not already downloaded may also be downloaded over-the-air.

Optionally, the mobile device may include a method composer (213) for the development of a new method file, which may be executed on the method processor (211) or transmitted to a remote location (e.g., another mobile device or a server) for execution.

For example, the user of the mobile device may modify the workflow of a module or an application even during the execution of the workflow. For example, the user of the mobile device may load a graphical representation of the workflow into the method composer, make changes to the workflow while the method processor is executing the previous version of the workflow, and save the new version of the workflow. When the new version of the workflow is saved, the method processor can continue the execution according to the new version of the workflow, starting from the module that is currently being executed. Thus, a workflow can be modified on-the-fly.

Further, the method processor may automatically adjust, or optimize, a workflow based on the usage pattern of a user. For example, if the user routinely skips a user interface form under certain conditions and comes back to the user interface form later, the method processor may optimize the workflow based on the typical execution paths of the user to avoid the presentation of the user interface form under these conditions, so that the user does not have to provide the input to skip the user interface form. Thus, the method processor may transform the workflow to allow the typical execution paths while eliminating the need to render the user input forms that are skipped.

The user interface forms may be designed to receive inputs that indicate whether the forms are skipped. Certain forms may provide information to the user without receiving input from the user. Other forms may be capable to receive user inputs. The user may skip a form because the user becomes familiar with the information provided in the form, or because the form does not provide useful information at this stage, or because the user prefers to deal with the form at a later time, or because a specific condition. The indication of skipping the form can be used by the method processor to automatically optimize the workflow according to the preference of the user as indicated by the actual execution paths. Further, when the user skips a user interface form, the user may be presented with an option to specify conditions, if any, under which the user interface form should be skipped. Thus, the method processor may customize the workflow for the user according to the user specified conditions. In general, different users may have different preferences; and the preference of a user may change as the user becomes familiar to the workflow.

A workflow may have a number of versions designed for users with different levels of familiarity with the task. Based on the statistical data collected from the execution of a workflow, the method processor may estimate the level of familiarity of the user with the task and automatically determine an appropriate version of the workflow for the user (e.g., to promote efficiency).

In one embodiment, a user interface module may be customizable for a number of different situations, which may be determined based on the location of the execution of the module, the time of the execution of the module, the customer for which the module is executed, and/or the user who executes the module, etc. The user interface module may be customized to have different graphics (e.g., for a decorative purpose), have different layouts, to have different sets of optional items/entries, to have different labels, help information, tutorial/training modules, etc.

Certain customization information, such as rules, preferred execution sequence, customized workflow/sub-workflow, graphics and settings, etc., can be dynamically received in the mobile device when the mobile device is at the service site. The customization information may be obtained from the customer at the service site, or from an integration server of the enterprise that dispatches the mobile device (e.g., based on the location of the mobile device).

For example, the customer at the service site may develop their customized version of a workflow, which can be pushed/downloaded to the mobile device for the execution of a workflow application for the customer. The workflow may have a number of customizable rules; and the customer at the service site may push the customized rules to the mobile device for the execution of a workflow application for the customer.

Alternatively, a user may customize the workflow using the composer running on the mobile device (e.g., in collaboration with the customer) to obtain a customized version of the workflow, which is then transmitted to an integration server for distribution to other mobile devices which may subsequently serve the same customer using the customized version of the workflow.

In FIG. 2, the method composer (213) includes a workflow generator (233) which is coupled to the visual guide (235) to allow the user to visually develop the workflow.

The method composer (213) may automatically determine the input/output data variables of the modules through introspection to help user to visually develop the workflow. After the user indicates the correspondence between the input/output data variables of the modules and a pool of global variables for the method file, the method composer (213) can automatically generate, in the method file, the links between the input/output data variables of the modules and the global variables of the method file. The method composer (213) can further be used to compose and compile task modules.

In general, method files and task modules can be developed on a computer with more processing power than a mobile device. For example, the method files and task modules so developed may be dispatched to the mobile device via an integration server (e.g., 105 in FIG. 1).

In FIG. 2, the mobile device includes a communicator (215) which includes various modules for data prioritization (252), check point based restart (253), cost-value determination (255), on-the-fly compression (257). The communicator (215) is used by the method processor (211) to download library code or updates to library code, data package (219), and to send request as a method module/application to a remote location for execution.

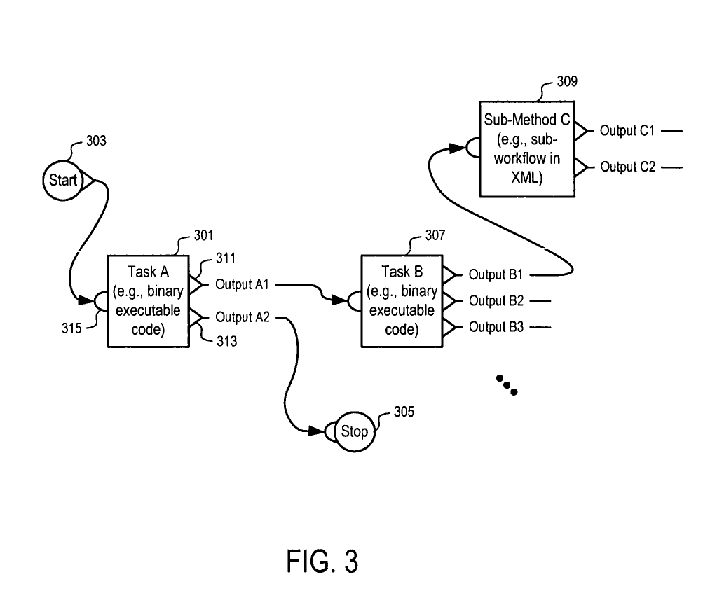

FIG. 3 illustrates a visual representation of a workflow. In FIG. 3, a workflow defined in a method file includes one start module (303). The workflow may or may not include a stop module (305). The workflow shows directed links from one module (e.g., 301) to another (e.g., 307) to indicate the flow. The workflow may call task modules (e.g., 301, 307) which may be in the same programming language as the workflow engine and method modules (e.g., 309) which may be in an XML format.

In FIG. 3, a module has an input port (e.g., 315). A link to an input port (e.g., 315) indicates a flow into the module (e.g., 301). A module has one or more output ports (e.g., 311, 313), corresponding to one or more different outcomes of the module. A link from an output port (e.g., 311) indicates a flow from the module to a direction indicated by the link under the condition that the module produces the corresponding outcome.

The condition under which the workflow flows from one module to another module may be based on a number of conditions, or based on simply the status of one (or more) outcome of the exiting module. For example, each module can be designed to output an outcome that is used by the workflow engine to determine the direction of the subsequent execution flow.

In general, the condition under which the workflow flows from one module to another module can be based on an expression which is a function of a number of variables accessible at the level of the workflow. For example, the expression may be a function of a number of global variables accessible to the modules in the workflow. The modules may update the values of the global variables during the execution.

A workflow can include a variety of modules, such as a user interface task module, a system task module, a sub-method workflow module, a remote module, etc.

A task module is in a programming language that is to be executed by the software and/or hardware platform which runs the method processor. The task module may be loaded into the same process of the method processor and executed in the same thread of the workflow engine. A workflow method (method module) may be in a programming language (e.g., Extensible Markup Language (XML), other markup languages, a custom designed language) that is to be interpreted by the method processor.

During the execution of a workflow method which calls a method module (or a task module), the method processor may check for the latest version of the method module (or the task module). If the latest available version of the method module is different from what is in the cache, the method processor can replace the version of the method module in the cache with the latest available version of the method module. Thus, the application can be hot updated without having to restart or shutdown the application.

For example, when an updated version of a method module is developed, an integration server may dispatch the method module in an XML file to the mobile devices, some of which may actually running an application which uses the method module. After the updated version of the method module is dispatched to a mobile device, the updated version of the method module becomes immediately available for use by the mobile device. For example, when the execution of a workflow application on the mobile device reaches the method module, the updated version of the method module can be executed without having to restart the workflow application. The cache manager may periodically determine whether the cached version of the method module is outdated. If the cached version is outdated, the cache manager can reload the latest version of the method module to update the cache. Thus, the application can be modified on-the-fly while the application is being executed.

An integration server may monitor the versions of modules on various mobile devices, keep a data set showing different method versions on different mobile devices, and manage the version control on the mobile devices. For example, the integration server may send out a list of customers that need customization. As the mobile device approaches a customer on the list, a customized version of a module can be downloaded (e.g., from the integration server, or from a server of the customer). The customized version may include a configuration file for a workflow application, a customized method file, a customized resource file, etc. The customization may be performed on the mobile device using a composer running on the mobile device; and the customization may be submitted back to the integration server for propagation to other mobile devices. The integration server may query the mobile devices to preload customizations to the mobile devices. Alternatively, a mobile device may check with the integration server for customization when the mobile device arrives at the site of the customer (or when the mobile device starts to execute a workflow for an identified customer). The customized version of a workflow may be downloaded and hot swapped to replace the non-preferred version after downloading the customized version. Further, the method processor may look ahead of the current execution of the workflow to anticipate the need for customized version of workflows for a scheduled task, so that the customized version may be downloaded before the module is needed.

When an updated version of a task module is developed, an integration server may dispatch the task module (e.g., in a programming language such as Java byte code or Microsoft Intermediate Language) to the mobile devices. After the updated version of the task module is dispatched to a mobile device, the updated version of the task module becomes immediately available for use by the mobile device. For example, when the execution of a workflow application on the mobile device reaches the task module, the updated version of the task module can be executed without having to restart the workflow application. The cache manager may periodically determine whether the currently loaded version of the task module is outdated. If the currently loaded version is outdated, the cache manager can unload the outdated version and load the latest version of the task module. Thus, the application can be modified on-the-fly while the application is being executed.

Further, in one embodiment, modules of a workflow application can be supplied on demand, after the workflow application is started. For example, the workflow application may be started on a mobile device in the absence of one or more modules (e.g., a task module or a method module). Before the workflow reaches the missing modules, the method processor may execute the application as if the modules have been pre-loaded in the mobile device. The method processor can attempt to obtain the missing modules from available network resources while the application is being executed. Thus, the modules can be hot supplied and updated, while the application is running.

When multiple versions of a module are provided to a mobile device, the method processor may be configured to execute the latest version, a particular version identified based on a version number of time of arrival at the mobile device, or provide an option to the user to select a version for execution. The configuration parameter may be presented in a configuration file for the mobile device, or a configuration file specific for the application, or a method file that specifies the workflow, or based a combination of these configuration parameters presented in different locations.

For example, the configuration file for the mobile device may specify the general preference of whether to run the latest version according to the version number or according to the time of arrival at the mobile device. The preference may be overwritten by the method file for the workflow, and/or be overwritten by a preference in the application specific configuration file, if provided. Version selection may also be performed based on other factors related, such as customer identity, location, performance goal, etc.

In one embodiment of the present invention, an updated version of a workflow may be provided to a method processor while a previous version of the workflow is being executed in the method processor. When the method processor is at a module that is used in both versions of the workflow, the method processor can load the updated version of the workflow and continue the execution of the workflow according to the updated version without having to stop or restart the workflow. It is not necessary to stop the execution of the previous version of the workflow and start the execution of the updated version of the workflow again from the beginning. Thus, the workflow can be modified while the workflow is being executed in the method processor, without having to stop the current execution of the workflow. Under certain conditions, the method processor may use an old version for a certain period of time.

For example, during the execution of a workflow, the log data of the execution of the workflow may be transmitted to a dispatcher for monitoring. When the dispatcher determines that the workflow is to be modified according to a recent event, the dispatcher may modify the workflow and transmit the modified version of the workflow to the mobile device (e.g., to include a bug fix, a new feature, a customization into the workflow). The modification may include altering one or more execution paths, inserting one or more execution path and/or references to new modules, and/or eliminating one or more modules. The modified version of the workflow can be transmitted to the mobile device. At a point where the workflow engine is at a module that is in both versions of the workflow, the workflow engine can hot swap the previous version of the workflow out of memory and continue the execution of the same module in the updated version of the workflow and direct the subsequent execution of the workflow according to the updated version of the workflow without restarting the execution of the workflow. Thus, the dispatcher may dynamically inject a sub-workflow into the workflow currently being executed on the method processor, or remove a scheduled sub-workflow out of the workflow that is currently being executed on the method processor.

Further, the method processor may operate in a loop of continuously receiving applications in the form of method files and selectively executing the method files. Thus, the workflow in the method processor may never end. For example, the method processor can be designed to process the applications in a queue. New applications can be added to the queue. When the queue is empty, the method processor waits for the arrival of new applications (e.g., via a network connection). Thus, the method processor may be considered as a virtual machine.

Further, in one embodiment, the method processor may lunch or start workflow applications in response to external events, such as in response to a change in availability of a network resource, or a signal detected by a sensor (e.g., controlled by the logger of the mobile device), or the start or end of an event, such as the start or end of a module or a workflow application. Thus, the method processor may process the workflow applications based on events generated at the mobile device, or based on the priority of the workflow applications, or based on the order of the queue for the workflow applications, or based on user selection.

The modules and/or workflow applications can be digitally signed to prevent tampering. To generate the digital signature, a digest is computed from the content of a module or workflow application using a one-way hash function, such as Message Digest 5 (MD5) or Secure Hash Algorithm-1 (SHA-1). The one-way hash function is such that a small change in the content would lead to a change in the computed digest; and it is very difficult to make a change in the content without changing the computed digest. The sender encrypts the digest using the private key of the sender so that the digest can be decrypted using the public key of the sender. If the digest is not encrypted with the private key of the sender, the digest cannot be correctly decrypted using the public key of the sender. The public key of the sender can be distributed to the recipients. Thus, when the recipient the decrypted digest matches the digest computed from the received the module or workflow, it can be determined that the digest is provided by the holder of the private key of the sender and the content of the module or the workflow application has not been tampered.

A method processor can be configured to execute modules and/or workflow applications that are digitally signed by a trusted entity (e.g., provided by one or more trusted entities who are in possession of the private keys of known public keys). When a module and/or workflow application is not from a trusted entity, the method processor may refuse to execute the module and/or workflow application, or present to the user of the method processor an option to determine the trustworthy of the received module and/or workflow application.

The digital signature of the trusted entity can also be used to create the digital certificate for distributing the public keys of other entities whose identity have been verified by the trusted entity. For example, the trusted entity may digitally sign the certificate that includes a public key of the holder of the certificate and information describing the holder of the certificate. When the public key of the holder of the certificate can be used to verify the digital signature of a module or workflow application, it can be determined that the sender of the module or workflow application is as described in the certificate. The recipient of the module or workflow application may decide the trustworthy of the module or workflow application and/or the sender based on the description of the holder of the certificate.

Further, to protect the content of the module or workflow application from authorized access, which may contain confidential data and/or business process, the sender may further encrypt the content with a public key of the recipient, such that those who do not have the private key of the recipient cannot correctly decrypt the content. The module or workflow application can be further compressed to reduce transmission time and transmission bandwidth requirement.

Further, secret key cryptography (symmetric encryption) in which the same key is used for both encryption and decryption can be used to protect the modules and/or workflow applications from tampering and unauthorized access. The method processor can be configured to execute the modules and/or workflow applications that are from authorized providers.

Different modules of a workflow application may be executed in a same thread. Alternatively, a method module which defines a sub-workflow can be executed in a separate thread. For example, the calling method file may specify whether the method module that is called in the calling method file is to be executed in a separate thread. When the method module is executed in a separate thread, the main thread may or may not wait for the completion of the thread of the method module. For example, when the outcome of the method module is not used to select the execution path following the method module, the main thread may not wait for the completion of that separate thread of the method module.

Further, for example, one execution path may lead to multiple method modules which are executed asynchronously in separate threads. Thus, a main thread may fork into multiple threads for asynchronous parallel processing.

Similarly, a task module may also be executed in a separate thread.

In one embodiment of the present invention, the behavior of the cache manager is configurable. The cache manager may be configured for all applications running in the method processor or for a specific application. For example, the method processor may use a general configuration file to indicate the default behavior of the cache manager. When the general configuration file is updated (e.g., modified or overwritten with a new version), the method processor can reload the configuration parameters automatically. Further, for a specific application, a configuration file can be used to adjust the configuration parameters for the specific application. For example, a configuration parameter can be used to specify the maximum number of tasks modules that can be cached by cache manager, or the maximum amount of memory that can be consumed by the cache. Thus, the cache manager can avoid consuming excessive memory resources and avoid degrading the performance of the workflow engine.

One embodiment of the present invention uses a Model View Control (MVC) paradigm. In the MVC paradigm, the user input, the modeling of the external world, and the visual feedback to the user are explicitly separated and handled by three types of objects, each specialized for its task.

The view manages the graphical and/or textual output to the portion of the bitmapped display that is allocated to its application.

The controller interprets the mouse and keyboard inputs from the user, commanding the model and/or the view to change as appropriate.

The model manages the behavior and data of the application domain, responds to requests for information about its state (usually from the view), and responds to instructions to change state (usually from the controller).

The formal separation of these three tasks can be particularly suited to mobile applications where the basic behavior can be embodied in three types of objects: View, Controller, and Model. The MVC behavior of the objects can be then inherited, added to, and modified as necessary to provide a flexible and powerful system. The division of labor within the MVC triad helps to design a flexible and powerful system.

Subclasses of View and Controller can be made available to provide ready made starting points for designing modules that can be used in a workflow. Applications can then be built through defining a workflow among the modules.

The separation of view and model allows the development of different ways to present the same data quickly. For example, different user interface task modules can be developed to present different user interface forms to manipulate the same data. Thus, the look and feel of the graphical user interface to manipulate the data can be changed without breaking the logic.

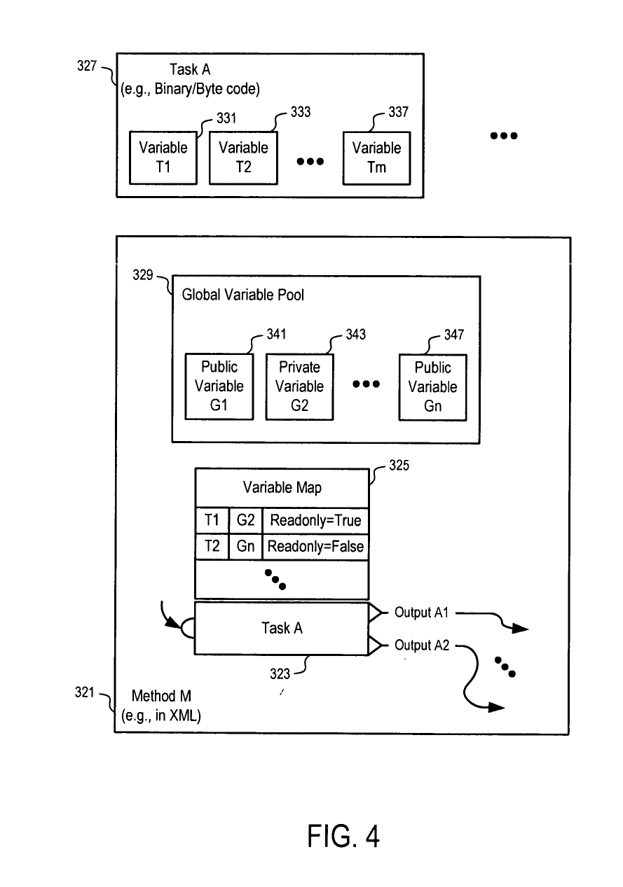

FIG. 4 illustrates a way to construct a workflow method. In FIG. 4, a workflow method (321) can be defined in an Extensible Markup Language (XML). A global variable pool (329) of the workflow method (321) includes a number of global variables (e.g., 341, 343, . . . , 347). The global variables of the global variable pool (329) are accessible to modules in the workflow method (321).

Some of the global variables can be defined as “public” (e.g., 341, 347) such that these public global variables are accessible to another workflow method (not shown in FIG. 4) when the workflow method (321) is used as a sub-workflow module in that method. Some of the global variables can be defined as “private” (e.g., 343) such that these private global variables are accessible only to the modules used within the workflow method (321).

The workflow method (321) identifies the modules (e.g., 323) used in the workflow method (321) and specifies flow directions from one module to another based on the outcome statuses of the modules.

A module (e.g., 323) of the workflow method (321) can be a task module (327) which can be in the form of binary code for the processor, or byte code for virtual machine in which the method processor is running. The task module (327) includes a number of variables (e.g., 331, 333, . . . , 337) accessible to the method processor at the workflow level.

In one embodiment, the workflow method not only identifies the task module (327), but also specifies the location from which the task module (327) can be obtained if the task module (327) is not already on the mobile device. For example, the location of the task module can be specified using a Uniform Resource Locator (URL). If the method processor determines that the task module (327) is not already on the mobile device, the method processor may start to download the task model according to the Uniform Resource Locator (URL). Further, in one embodiment, the method processor may use the Uniform Resource Locator (URL) to check for an updated version of the task module, based on a set of pre-determined rules.

The instructions for the task module (327) may be stored separated from the workflow method (321). The workflow method (321) contains a reference to the task module (327), which specifies the location where the instructions for the task module (327) can be found. A cache manager may use information of the location of the task module to pre-load the module into memory.

The workflow method (321) may include a variable map (325) which specifies the relation between the global variables of the workflow method (321) and the variables of the task modules.

For example, in FIG. 4, variable T1 (331) of the task module (327) is to be linked to the global variable G2 (343), in which the global variable G2 (343) is readonly to the variable T1 (331) of the task module (327). Thus, before the execution of the task module (327), the method processor provides the value of the global variable G2 (343) as an input to initialize the variable T1 (331) of the task module (327); since the global variable G2 (343) is readonly to the task module (327), the execution of the task module (327) has no effect on the global variable G2 (343).

For example, in FIG. 4, variable T2 (333) of the task module (327) is to be linked to the global variable Gn (347), in which the global variable Gn (347) is not readonly to the variable T2 (333) of the task module (327). Thus, before the execution of the task module (327), the method processor provides the value of the global variable Gn (347) as an input to initialize the variable T2 (333) of the task module (327); since the global variable Gn (347) is not readonly to the task module (327), the method processor uses the content of the variable T2 (333) of the task module (327) to update the global variable Gn (347) after the execution of the task module (327).

Thus, the variable map (325) specifies the way the method processor provides the data to the modules from the global variable pool (329) and updates the global variable pool (329) according to the variables of the task modules.

The method file may further specify whether or not a local variable or a global variable in the method file is to be logged. When a variable is flagged for logging, the method processor automatically records the state of the variable when the variable is accessed by the workflow engine. The method file can specified that an entry for a variable is to be recorded to show the value of the variable at the time of entering a module, exiting a module, or both, or none. The logging of local and/or global variables can be part of a more comprehensive logging capability of a method processor.

The state of an instance of a workflow method can be maintained by the corresponding global variable pool. Thus, different instances of the same workflow method may co-exist on a same method processor.

A workflow method may present the output of the last executed module as the output status of the workflow method. A stop module can be optional. When a stop module is used, the stop module takes the output of the module which is executed just before the stop module as the output of the workflow method. In general, a workflow method may have a number of modules which can be the last executed one, depending on the execution results. The set of possible outputs of the workflow method includes the possible outputs of these modules that can be the last executed module of the workflow method.

A workflow method may select a global variable of the sub-workflow method as the outcome variable such that the value of the outcome variable can be used as the status of the outcome of the sub-workflow method.

Alternatively, a workflow method may designate a global variable as the outcome variable such that the value of the outcome variable can be used as the status of the outcome of the workflow method when the workflow method is used as a module in another workflow method.

Alternatively, a workflow method may designate a global variable as the default outcome variable; and a calling workflow method that uses the workflow method as a sub-workflow can use the default outcome variable to direct the subsequent flow or specify an alternative public global variable of the sub-workflow method as the outcome variable.

A calling workflow method may define a proxy to another workflow method that is to be used as a sub-workflow. The proxy specifies which of the public global variables of the workflow method are the local variables of the sub-workflow. A variable mapping between the local variables of the sub-workflow method and the global variables of the calling workflow method allows the method processor to feed the sub-workflow according to the data stored in the global variables of the calling workflow when entering the sub-workflow method and to update the global variables of the calling workflow according to the corresponding variables of the sub-workflow method when exiting the sub-workflow method.

The global variable pools of workflow methods can be used to link calling workflows with sub-workflows through variable mapping so that the workflows can be built in a hierarchical way.

A remote module may be a user interface task module, a system task module, or a sub-method workflow, which is to be executed at a location that is remote to the method processor.

Composite Application

One embodiment of the present invention provides a flexible architecture for composite applications (e.g., for mobile devices).

Composite applications are new applications that are built from parts of existing applications. One embodiment of the present invention provides architecture to build composite applications quickly and use them in the mobile applications.

Route accounting, as a vertical market application for the enterprise, is an example of a composite application. It blends account receivables, invoicing, material return authorization, and CRM (Customer Relationship Management). Using the architecture according to present invention, composite applications for mobile applications can be quickly developed, configured, tested, debugged, and deployed.

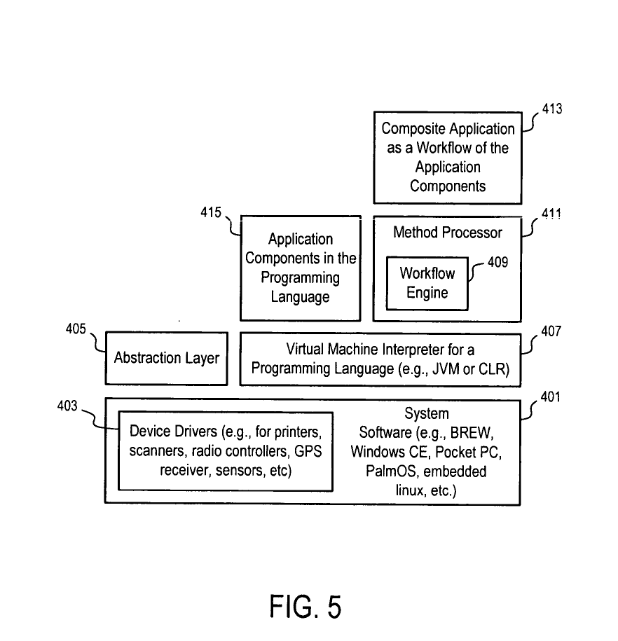

FIG. 5 illustrates a software architecture structure for providing composite applications. In FIG. 5, a method processor (411) including a workflow engine (409) runs on top of a virtual machine interpreter (407) for a programming language, such as a Java Virtual Machine (JVM) or a Common Language Runtime (CLR).

The virtual machine interpreter (407) can be implemented as a software platform running in the environment of system software (401), such as BREW, Window CD, Pocket PC, PalmOS, embedded linux, etc. The system software typically includes device drivers for peripheral devices, such as printers, scanners, radio controllers, GPS receiver, sensors, etc.

In FIG. 5, an abstraction layer (405) is used by the method processor (411) to encapsulate implementation details of various different types of devices from the application programs to be developed for the method processor.

The application components (e.g., task modules) can be developed in the programming language of the virtual machine interpreter (407). The method processor (411) (including the workflow engine (409)) can also be in the programming language of the virtual machine interpreter (407).

During the execution, the method processor dynamically and selectively loads applications components as part of the running process of the method processor. Thus, the capability of the method processor to process different workflows can change dynamically during the execution, through loading and unloading the application components.

Application components originally developed for different applications can be loaded into the method processor without distinction. Thus, the application components (e.g., task modules or sub-workflow methods) from different applications can be re-arranged in a new workflow for a new application.

For example, a composite application (413) can be developed quickly by specifying a workflow of the application components which are previously developed for one or more different applications. Further, the components of an original application can also be easily re-arranged to update the high level business logic/process.

Thus, even when the source code of the application components (415) is not available (and may be obfuscated), access to the interface definition of the components (e.g., the task modules) is still available. The method processor (411) uses the interface definition of the components to load the modules, provide data to the modules and obtain data from the modules. Such interface definition can be used in the construction of new workflow methods.

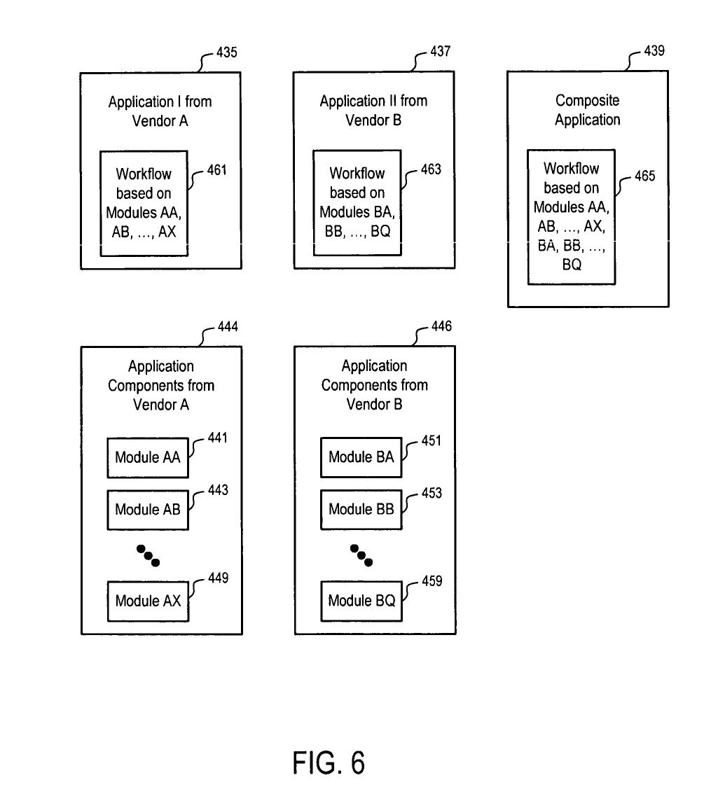

FIG. 6 illustrates a way to build a composite application. For example, in FIG. 6, a vendor A may provide application components (444) (e.g., coding and compiling the modules from source code), including a number of modules (441, 443, . . . , 449). The vendor A may provide an application (435) which is in the form of a workflow (461) based on the modules (441, 443, . . . , 449) from the vendor A.

Similarly, in FIG. 6, a vendor B may provide application components (446), including a number of modules (451, 453, . . . , 459). The vendor B may provide an application (437) which is in the form of a workflow (463) based on the modules (451, 453, . . . , 459) from the vendor B.

In one embodiment of the present invention, a new composite application (439) can be developed as a workflow based on modules (441, 443, . . . , 449) from the vendor A and modules (451, 453, . . . , 459) from the vendor B, without the need for source code access to any of the modules (441, 443, . . . , 449 and 451, 453, . . . , 459).

Thus, components of existing application can be used to generate customized versions of applications that are tailored to the individual needs of the mobile application users and/or their customers.

User Interface Processing

In one embodiment of the present invention, a method processor is designed to load a subsequent user interface task module before the closing of the current user interface task module.

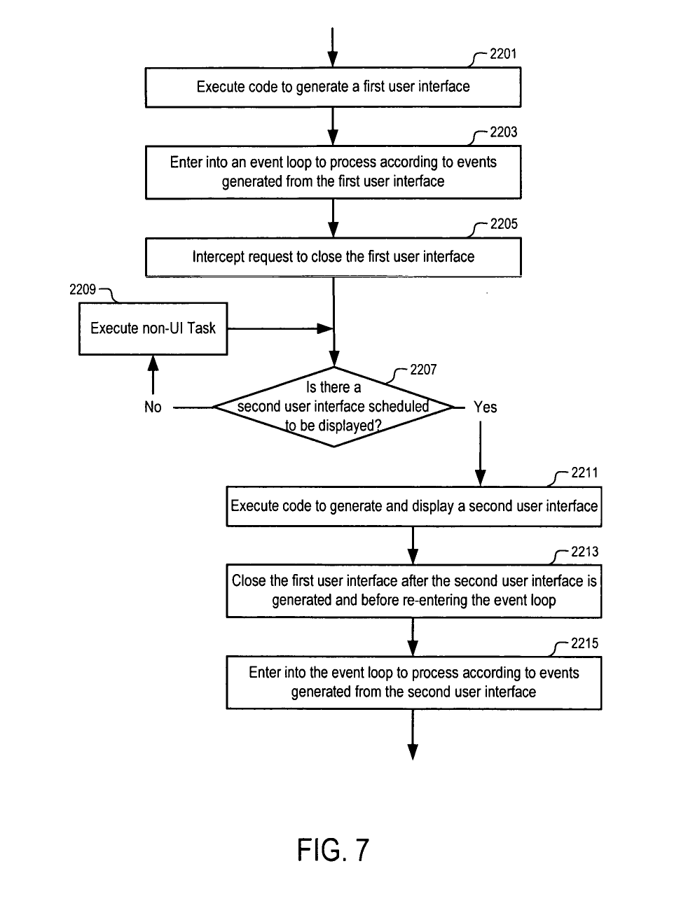

FIG. 7 shows a flow diagram of a process to render user interfaces for sequential display. In FIG. 7, after the code for a task module is executed (2201) to generate a first user interface (e.g., a user interface form), the system enters (2203) into an event loop to process according to events generated from the first user interface.

After the method processor intercepts (2205) the request to close the first user interface, it is determined (2207) whether there is a second user interface scheduled to be displayed.

If there is no user interface scheduled to be displayed, one or more non-UI tasks are executed (2209), which may lead to a user interface task along a path in a workflow.

If there is a second user interface scheduled to be displayed, the code for a task module is executed (2211) to generate and display the second user interface. After the second user interface is generated and ready for display, the first user interface is closed before re-entering the event loop to handle user events for the second user interface. The system then enters (2215) into the event loop to process according to the events generated from the second user interface.

The second user interface can be generated and painted over the background (or buffered) before the first user interface is closed. The second user interface may be painted above the first user interface or just underneath the first user interface. Thus, when the first user interface is closed, the second user interface is displayed over the background. Since the closing of the first user interface is delayed, the time duration between closing the first user interface and displaying the second user interface is reduced/eliminated. Such an arrangement can eliminate/reduce the flash/flicker which is caused by briefly displaying the background after the first user interface is closed and before the second user interface is displayed.

Thus, the method processor can intelligently schedule the closing of the user interface of one module of a workflow and pre-load/cache the user interface of another module of the workflow to eliminate the brief display of a background (or another form).

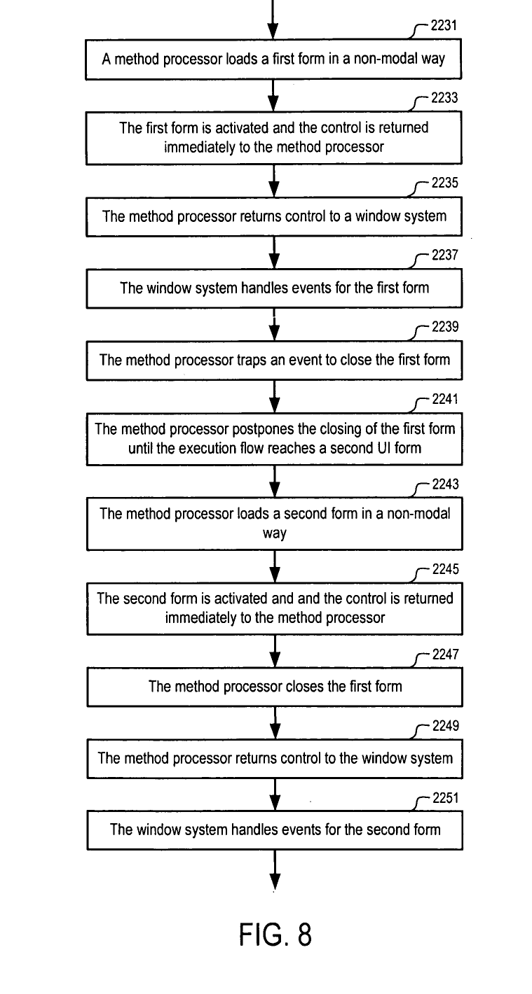

FIG. 8 shows a flow diagram of another process to render user interfaces for sequential display. In FIG. 8, after a method processor loads (2231) a first form in a non-modal way, the first form is activated and the control is returned immediately to the method processor (2231). The method processor returns (2235) control to a window system, so that the window system can handle (2237) events for the first form.

After the method processor traps an event to close the first form, the method processor postpones (2241) the closing of the first form until the execution flow reaches a second UI form. After the event to close the first form, the processor may execute one or more non-UI modules, if there are any according to the workflow, before the execution flow reaches the second UI form. The method processor loads (2243) a second form in a non-modal way such that, after the second form is activated, the control is returned immediately to the method processor (2245). The method processor then closes (2247) the first form and returns (2249) the control to the window system to handle (2251) events for the second form.

Thus, the method processor loads modal forms in a non-modal way to allow the subsequent form to be displayed over the background (and over other forms), before the previous form is closed.

Different user interfaces for different task modules in a workflow are typically designed to be loaded in a modal way to prevent the user from interacting with the subsequent form before the current form is closed. The method processor (virtual machine for workflow) can load the forms in a non-modal way to allow the subsequent form to be generated over the background before closing the previous form (thus, allow both forms to coexist briefly). The method processor allows the forms to coexist briefly, between the user input to close the previous form and the system gaining the control to handle events for the subsequent form. The method processor can prevent the user from interacting the subsequent form before the previous form is closed (e.g., loading the subsequent form after trapping the event to close the current form and closing the form before entering the event loop to hand user inputs for the subsequent form).

A UI form may take up the entire screen of the display device, or the entire main window of an application, or a portion of the screen, or a portion of the main window. The screen may show the windows/forms of multiple workflow applications or modules that are executed asynchronously in different threads. Forms of an application may be rendered inside one main window or different windows. Flash/flicker may be the result of the brief display of the desktop/screen background, or the background of the main window, or a portion of the desktop/screen background, or a portion of the background of the main window, or a portion of another window/form, in a time period between the close of the old form and the display of the new form. The screen background is displayed when no application window is displayed in at least a portion of the screen. The background of the main window is displayed when no form/window is displayed over at least a portion of the main window. To remove the flash/flicker, a new UI form may be rendered on top of the old UI form that is to be closed, or be rendered under the old form but above other forms, windows, and the desktop/screen background. The size of the new form and the old form that is to be closed may be the same or different.

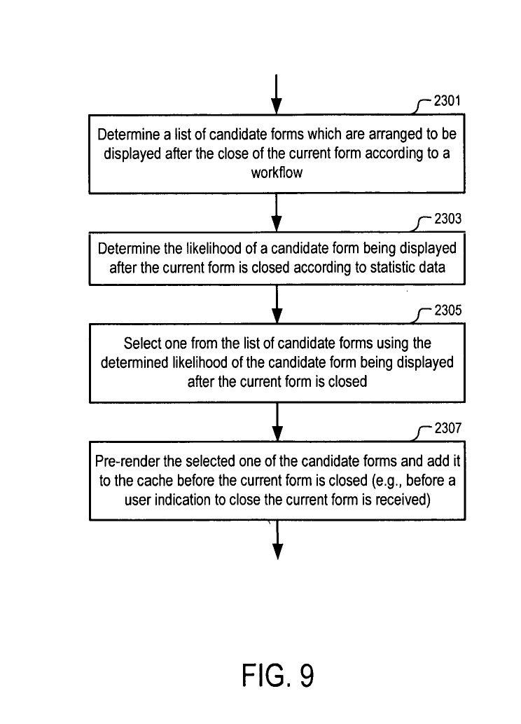

FIG. 9 shows a flow diagram of a process to selectively pre-construct forms. In FIG. 9, a list of candidate forms are determined (2301), which are arranged to be displayed after the close of the current form according to a workflow. The likelihood of a candidate form being displayed after the current form is closed is determined (2303) according to statistic data. The method processor selects (2305) one from the list of candidate forms using the determined likelihood of the candidate form being displayed after the current form is closed. The selected one of the candidate forms is pre-rendered (2307) and added to the cache before the current form is closed (e.g., before a user indication to close the current form is received).

The example in FIG. 9 includes the caching of user interface modules. However, the pre-loading and caching operations may also be performed for other types modules also. For example, a cache manager may look ahead of the current module that is being executed in the workflow engine and determine candidate modules that are arranged to be executed after the current module. The likelihood of a candidate modules being executed after the current module can be determined. For example, the likelihood may be determined based on statistical data obtained from past execution of the workflow on this mobile device and/or other mobile devices and/or based on predetermined weighting factors. One or more modules can be selected from the set of candidate modules for pre-loading and caching based on the determined likelihood.

A cache manager may run in a thread separate from the workflow engine to avoid degrading the performance of the workflow engine which runs the high priority operations. The cache manager can determine the list of candidates, determine the likelihood and select forms for pre-rendering and/or caching. The cache manager becomes active when the thread of the workflow engine is in a time period in which the demand for computation power is low (e.g., when the system is idle, when waiting for user to provide input to a user interface module, or when waiting for a network connection or other events).

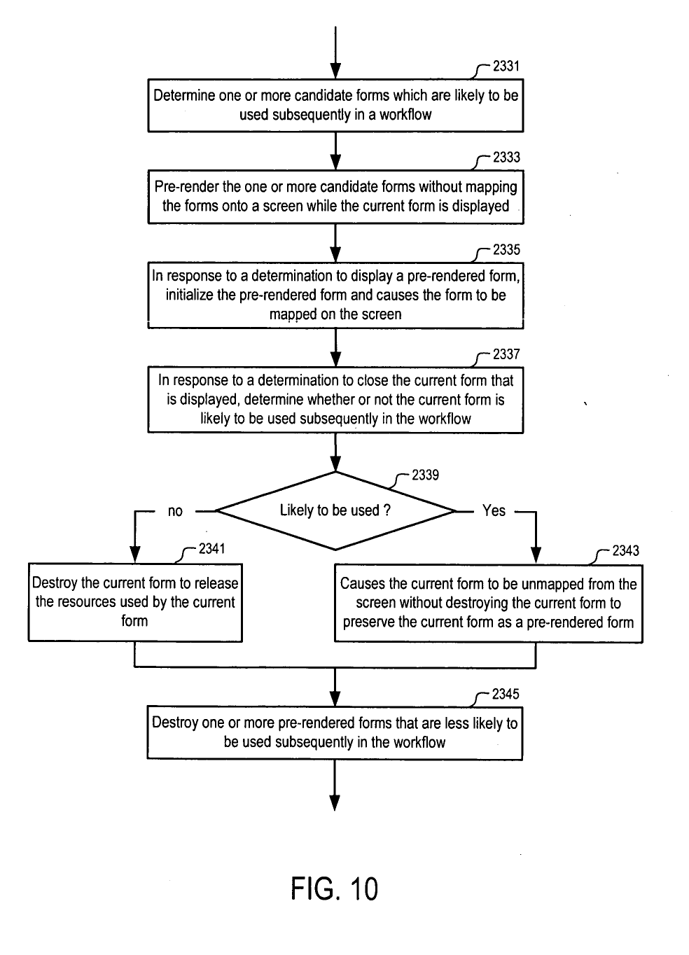

FIG. 10 shows a flow diagram of a process to selectively pre-construct forms. In FIG. 10, after one or more candidate forms which are likely to be used subsequently in a workflow is determined, the one or more candidate forms are pre-rendered without mapping the forms onto a screen while the current form is displayed.

In response to a determination to display a pre-rendered form, the pre-rendered form is initialized (2335) and caused to be mapped on the screen.

In response to a determination to close the current form that is displayed, it is determined (2337) whether or not the current form is likely to be used subsequently in the workflow.

If operation 2239 determines that it is likely to be used, the method processor causes (2343) the current form to be unmapped from the screen without destroying the current form to preserve the current form as a pre-rendered form.

If operation 2239 determines that it is not likely to be used, the method processor destroys (2341) the current form to release the resources used by the current form.

Further, the method processor can optionally destroy (2345) one or more other pre-rendered forms that are less likely to be used subsequently in the workflow.

Data Collection and Utilization

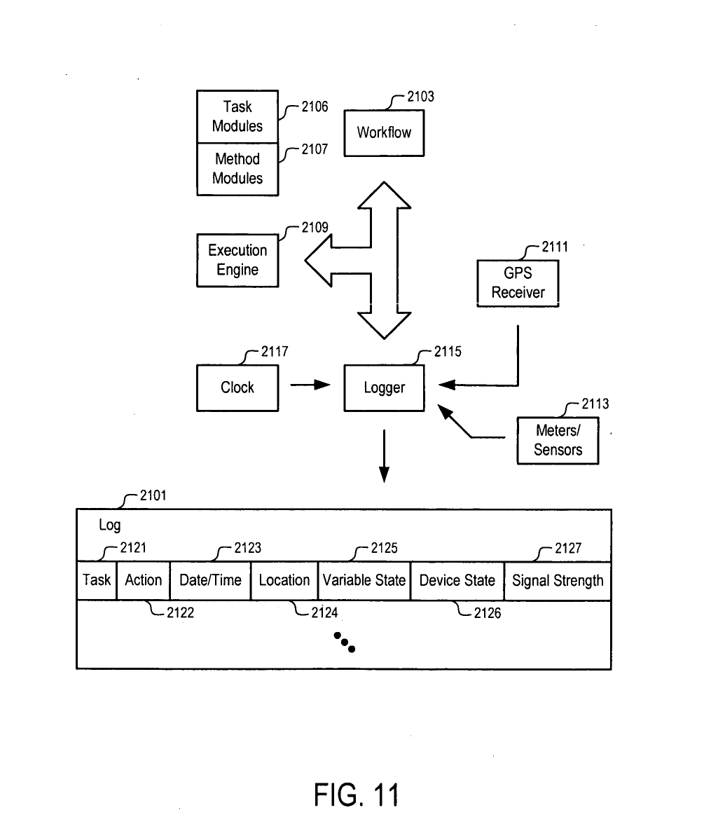

FIG. 11 illustrates a way to obtain log data. In FIG. 11, a logger (2115) is coupled to the execution engine (2109) to record time, location and other sensor/meter information relative to events and/or data associated with the execution of the workflow (2103).

The workflow (2103) is typically provided to the execution engine (2109) in a method file (e.g., in XML) which specifies the direction of flow among a number of modules, such as task modules (2106) and method modules (2107). The task modules (2106) can be in the same programming language as the execution engine (2109) so that the task modules can be loaded (e.g., as a shared library) into the execution engine (2109) and executed as part of the execution engine. The method modules (2107) can be in method files (e.g., in XML) which specifies the direction of flow among task modules and/or other method modules.

At a time of an event in the execution engine (2109) which causes the logger (2115) to generate a record, the logger (2115) can retrieve the corresponding time information from clock (2117), the corresponding location information from GPS receiver (2111), and other sensor/meter information from meters/sensors (2113) and record the time, location and sensor/meter information together with event information obtained from the execution engine (2109) and/or system information about the mobile device.

For example, the logger can record the time when a module (e.g., a task module or a method module) is started, the memory status when the module is started, the immediate prior module which leads to the current module, information about the module such as the name, resource, type, and the source of the module (e.g., where the module comes from, the provider of the module), any access to the global variable pool (e.g., reading, writing, etc.), the outcome of the module when the module exits, the duration of the execution of the module, which is the next executed module, etc. The logger provides the location stamp and the time stamp for the information logged. The logged data can be used to determine duration of the execution of subparts of a workflow. The logged data may further include user input such as keystroke or data input sequencing, typos, errors, connections, data entry types (e.g., scanner, keyboard, etc.)

In one embodiment of the present application, the execution engine is designed to process the method files received as workflow applications in a queue. When the queue is empty, the execution engine waits for the arrival of new workflow applications (e.g., received over a network connection, or generated by the execution engine). A graphical user interface may be presented to display the queue. The execution of a workflow application may be in response to a user selection of the workflow application or in response to a determination that the workflow application has a sufficiently high priority to be initiated automatically. Some workflow applications may be executed once and be removed from the queue. Some workflow applications may be executed and returned to the queue for future execution. Thus, the execution engine can be considered executing a queue processing application which may never end; and the workflow applications in the queue can be considered as method modules of the queue processing application. The queue processing application may also be described as a workflow which can run various other workflow applications as sub-workflows (synchronously or asynchronously). Thus, multiple workflow applications may run asynchronously in different threads.

The logger can record the information about when the workflow application is received, load, executed, etc. The logger can further record when updates to the modules are received and from where.

In general, the logger stamps the information obtained the execution engine with information obtained from various sensors and meters, such as clock, GPS receiver, etc.

For example, a signal sensor can be used to determine the signal strength of a wireless communication connection (e.g., Bluetooth, WiFi, WiMax, or cellular data communication connection). For example, a meter can be used to determine the gas level in the tank of a vehicle (e.g., through a connection to a vehicle bus). For example, a temperature sensor can be used to determine the current temperature (e.g., of the mobile device, a compartment of the vehicle in which the mobile device is placed, etc.).

For example, a mobile device may be equipped with, or connected with, a digital camera (e.g., a still picture camera or a video camera) and/or a microphone. The mobile device may use the camera to capture images, and/or use the microphone to capture sound clips, as log data. For example, a mobile device may be equipped with, or connected with, a phone; and the mobile device may use the phone to collect information as part of the log data.

The mobile device may further log data based on the usage of the camera or phone or other peripheral devices, such as a printer, a scanner, a bar code reader, a Radio Frequency Identification (RFID) reader, etc. For example, when the camera is operated by the user, or when the phone starts or ends a call, the mobile device may automatically log the event in association with other sensor data (e.g., the time, location, temperature) and workflow related data (e.g., the state of the workflow engine and the memory status). Thus, from the log data it may be determine when, with who, for how long and in what circumstance (e.g., relative to the execution of a workflow application) the user makes phone calls. For example, the Radio Frequency Identification (RFID) reader may be used to poll surrounding RFID tags to obtain RFID tag information as part of the log data.

Further, for example, the mobile device may be equipped with one or more network communication interfaces for wired and/or wireless communication connections. The mobile device may automatically determine the availability of the communication connections. Changes in the availability of the network communication connections may be events to cause the mobile device to create log entries. And other events that cause the creation of log entries may also cause the mobile device to determine the current availability of the network communication connections and save the availability data in association with other sensor data and/or workflow data in the log entries.

Further, the mobile device may use the network communication connections as data sensors to collect data as part of the log data. For example, at the time of a log event, the mobile device may use the network connection to poll a “remote sensor” for data that can be include with the log entry. The “remote sensor” may be an application running on another mobile device, an application running on a server, a web page for accessing certain data, the status of an equipment or system, etc. For example, the mobile device may communicate with a temperature sensor installed in a cooler of a customer (e.g., through a Bluetooth or WiFi connection) generate a log entry when a temperature from the sensor is available, and add the temperature data to entries that are logged in response to events while the temperature data is available. For example, the mobile device may retrieve inventory information from the customer as log data. For example, the mobile device may include an RFID reader, which reads the RFID tags at the site of the customer (e.g., for the products that have been previously delivered to the customer) to perform an inventory operation for the customer; and the inventory data may be further pushed to a server of the customer as a service for the customer. Thus, a sensor may be a software based sensor, a hardware based sensor, or a sensor partially implemented in software and partially implemented in hardware. The sensor may be hardwired to the mobile device, or coupled to the mobile device through wired or wireless communication links. An log event may cause the mobile device to poll the remote sensor for data; and the certain events associated with the remote sensor may also generate a log event to poll other data.

The mobile device may analysis log data related to a customer and provide feedback and/or suggestion to the customer. For example, the mobile device may determine a performance indicator of the customer and compare that to an organizational goal of the customer. The mobile device may optimize a workflow based on the performance indicator for execution on the mobile device, or for execution on a device of the customer. The mobile device may analyze the log data related to the customer and provide additional offers to the customer based on the result of the analysis. Based on the analysis of the log data, the mobile device may change certain terms of service on-the-fly, with or without further communication with a dispatcher. Further, incentive programs for each customer may be customized based on the result of the analysis of the log data related to the corresponding customer.

Thus, the logging of data may be in response to events generated in the execution engine and/or in response to events generated in the peripheral devices and/or remote sensors.

Further, the network connections may be used to push log data out to a “data sink”, in additional to poll remote sensors to collect data. For example, a mobile device may deliver log data to one or more “data sinks”, in additional to creating a log entry on the mobile device. A data sink may be an application running on another mobile device, an application running on a server, a web site for collecting certain data, etc. For example, the mobile devices of one company may be used to push log data of workflows executed for its customers to servers of their respective customers so that the customers may analyze the log data to improve their business practice. The data may be transmitted to the respective customers at the time the data is logged, if network connections is available, or transmitted in batch mode. For example, at the time of log data creation a log data entry may be provided through a Bluetooth or WiFi connection to a customer, if the connection is available at that time, to provide the log data to the customer. The log data can be useful to the customer. Thus, the customer may receive the data collection service in additional to the regular service from the user of the mobile devices. For example, the log data may provide the customer the indication of how the representative of the customer (e.g., an employee or a sale person) performs during a transaction based on a workflow executed on the mobile device, while the mobile device is at a location of the customer. For example, the mobile device may poll a RFID tag that is indicative of identity of the representative of the customer (or take a digital picture, or record a sound clip); the mobile device may provide to the customer the time and duration of tasks performed in cooperation with the representative of the customer; the mobile device may provide statistical averages for the durations to perform these tasks as performance indicators, etc.

When the workflow enters a module (e.g., a task module or a method module), the execution engine (2109) provides the name of the module and the action of entering the module to the logger (2115) so that the logger may record the task (2121) and action (2122) with the date/time (2123) obtained from clock (2117), the location (2124) obtained from GPS receiver (2111), and/or other sensor data. Further, the execution engine (2109) can provide the values of the variables related to the module (e.g., global variables of a global variable pool and/or local variables of the module) to record the variable state (2125). The logged data can further include the device state (2126) (such as the memory usage level and CPU usage level) and signal strength (2127) obtained from a sensor for a wireless communication connection.

For example, the logger may record the time when and the location where the wireless communication connection and other network resources are available, as the execution engine enters or exits modules of a workflow and/or as the availability changes.

The execution engine (2109) and the logger (2115) may run in a same thread so that the data logging is synchronous with the execution of the workflow (2103). Alternatively, the logger (2115) and the execution engine (2109) may run asynchronously in separate threads to reduce/limit the impact of activity of the logger on the execution of the workflow (2103).

During the execution of the workflow (2103), the execution engine performs various operations, such as feeding a module with data from a global variable pool when entering the module, retrieving data from local variables of the module, storing the retrieved data into the global variable pool when exiting the module, and intercepting user interface events for the user interface module, etc. The operations of the execution engine can generate events to cause the logger (2115) to recorded the time, location (when available), and other available sensor/meter data in connection with data supplied from the execution engine related to the operation, such as the value of the global/local variables, the memory state of the execution engine, etc.

In general, any activities by the execution engine (2109) in connection with the execution of the workflow (2103) can be used to generate data logging events to record information about the activities together with the corresponding time, location, and meter/sensor information. Thus, the log data can be collected without having to code the individual task modules to perform the data logging operations.

The intensity of data collection by the logger (2115) may be controlled in a number of ways. For example, a method file for the workflow (2103) may associate level identifiers with the modules used in the workflow. For example, one module in the workflow may be designated at level 1; and another module in the workflow may be designated at level 3. When the method processor is instructed to collect data from modules designated at level 3 and above, the data logging events associated with modules that are designated at level 2 or below are ignored or not generated at all; and the data logging events associated with modules that are designated at level 3 or above are acted upon to record data records. For example, a threshold level indicator can be provided to the execution engine; if the execution engine determines that the current module is designated at a level lower than the threshold level indicator, the execution engine does not generate data logging events for the module; otherwise, the execution engine generates the data logging events for the module (e.g., as the workflow enters or exits the module or accesses the global variable pool, etc.).

There can be a number of different ways to inform the method processor about the threshold level indicator. For example, a configuration parameter may be specified as part of the method file which defines the workflow application; and the configuration parameter specifies the threshold level such that, when a module used in the application is designated at a level on or above the threshold level, data is logged for that module; otherwise, data is not logged for that module. The designation of the levels of the modules can be also be specified in the method file (e.g., in the tag where the module is identified, as an element or an attribute). Thus, the same module may be designated at different levels in different method files.

Further, for example, the configuration parameter may be specified in a configuration file for the workflow application. Further, a configuration file for the mobile device can specify a threshold level for the configuration parameter, which can be used as a default when the parameter is neither specified in the application specific configuration file, nor in the method file of the workflow application.

The data items to be collected may also be configured in a number of ways. For example, some of the global variables/local variables may be configured in the method file so that the variables are logged when entering the module, and/or existing the module, or not to be logged.

For example, a configuration file for the mobile device or for a specific application may specify which meter/sensor data should be logged when available and which meter/sensor data could be ignored even when available.

For example, a configuration file for the mobile device may define a number of log profiles, each of which indicates a set of data items to be logged when available and a set of events that would cause logging; and a configuration file for a specific application, or the method file of the workflow application, can specify a log profile to be used by the method processor to control the logging activity.

In general, different ways to specify the level of data logging intensity can be used in combination to provide a hierarchical system to specify filtering criteria to control the logging intensity. Thus, a suitable amount of data can be collected during the execution of the workflow application.

The log data generated by the logger (2115) can be transmitted as a live data stream from the mobile device to a server system (or another mobile device) for real time monitoring and control. The log data can also be stored on the mobile device for batch delivery through a network connection. Further, different types of log data may be assigned different level of benefits. Based on a cost-benefit analysis, different types of log data can be transmitted at different time through different types of network connections.

In one embodiment of the present invention, a method processor can capture and log the screen images of user interface tasks (e.g., for documentation).

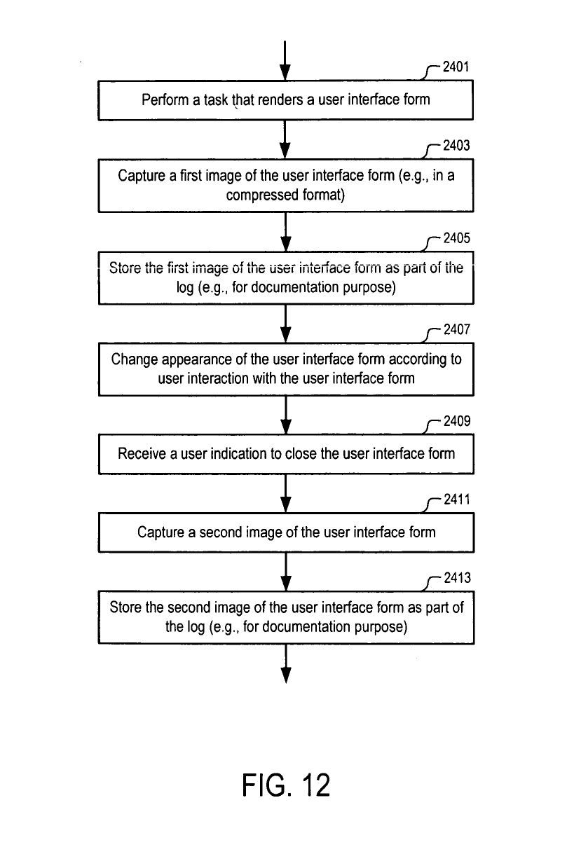

FIG. 12 shows a flow diagram of a process to log screen images of user interfaces by a method processor. In FIG. 12, after a task that renders a user interface form is performed (2401), the method processor can capture (2403) a first image of the user interface form (e.g., in a compressed format) and store (2405) the first image of the user interface form as part of the log (e.g., for documentation purpose). The screen image may be captured in a pixel format and compressed using a lossless compression technique. When a lossless compression technique is used, the decompressed image data will be the same as the original image data. Alternatively, or in combination, a lossy compression technique can also be used. When a lossy compression technique is used, the decompressed image data may be different from the original image data. The method processor may dynamically determine whether to compress the image data and the compression technique to be used if it is determined to compress the image data, based on one or more factors such as network connection availability, bandwidth of available network connection, current processor load status, memory status of the mobile device, etc., to optimize the performance of the system. The mobile device may also use a circuitry other than the main processor to perform image compressing.

The stored log data can be transmitted in a batch mode. Alternatively, the captured screen image can be transmitted (e.g., substantially in real time) to a server system (or to a mobile device) through an available network connection (e.g., through a local area network connection, or a WiFi connection, etc.).

In FIG. 12, after the appearance of the user interface form is changed (2407) according to user interaction with the user interface form, a user indication to close the user interface form may be received (2409). The method processor can then capture (2411) a second image of the user interface form and store (2413) the second image of the user interface form as part of the log (e.g., for documentation purpose).

In one embodiment of the present invention, when the method processor is instructed to run in a documentation mode (e.g., through an application specific configuration file, or a configuration file for the method processor), the method processor can automatically run through modules to capture the screen images of graphical user interfaces as part of the log stream.

For example, when in a documentation mode (or other execution mode), the method processor can load a user interface task module, capture the screen image of the form generated by the task module, automatically close the form (without user input or user interaction with the form), and automatically select a path that has not been previously followed in the documentation run of the workflow, and repeat the execution of workflow to cover all task modules and all execution paths among the modules. Thus, without user interaction, the method process can automatically run through the modules of the workflow to capture screen images of various user interface forms.

An indication to run the workflow in a documentation mode may be provided in a configuration file for the device, in the configuration file for the workflow application, or in the method file of the workflow application.

Alternatively, the method processor may also capture screen images of user interface forms in a mode in which the user can provide input and interact with the user interface forms.

Further, the method processor may selectively intercept user interface events which may cause the change of appearance of the user interface forms and capture screen images in response to such user interface events.

The captured screen images can be used for the documentation of the workflow application, used as a training tool (e.g., when compiled into a training video), etc.

One embodiment of the present invention includes the use of log data to optimize/improve the business process of a mobile application.

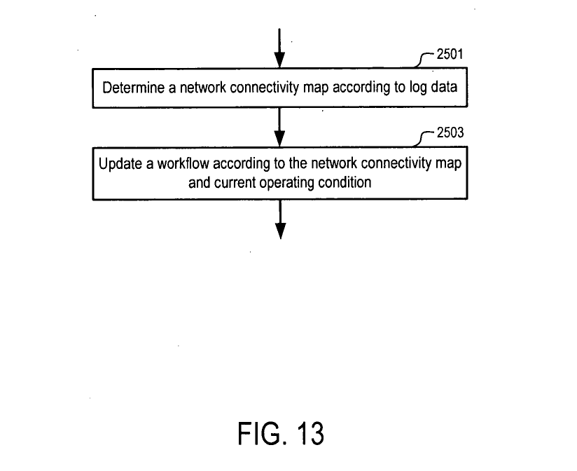

FIG. 13 shows a flow diagram of a process to improve workflows using log data. A network connectivity map according to log data is determined (2501) and used to update (2503) a workflow according to the network connectivity map and current operating condition. For example, based on the current speed and travel direction of the mobile device, the method processor may predict the time to outage of network connection (e.g., moving into a region where wireless network connection is not available). The estimation may be improved with past log data that are generated during the execution of the same or similar workflow application. In anticipation of the network outage, the method processor may reschedule the execution of the current workflow or decrease the priority of the current workflow to allow communication operations which require the network connection to be perform before the outage of network connection.

Further, based on the pattern of network outage relative to the execution of the workflow application, the flow of modules in the workflow application can be rearranged/updated to make use of the available wireless network connection and reduce or eliminate the dependency on network connection for the time period in which the mobile device is in the region without network connections. For example, data and/or modules which may be needed during the execution of the workflow while the mobile device is in such a region can be pre-loaded into the mobile device before the mobile device reaching this region.

The network connectivity map may be generated based on the log data of the mobile device and/or other similar mobile devices.

Further, the network connectivity maps which show the location and/or time of network availability can be collected from different mobile devices into a server to generate a composite map for a service area. Portions of the composite map may then be selectively transmitted to individual mobile devices to aid the mobile devices in predicting the outage of network connection.

Based on the availability map of the service area (e.g., as a function of time of the day), the dispatcher or application developer can optimize the mobile applications by avoiding the dependency of network resources while mobile devices are in the “blind spots” in which network connectivity is not available (in specific time and space location).

For example, before a mobile device enters a “blind spot” for network connectivity, the method processor of the mobile device may start a communication session which may or may not be previously scheduled. The communication session may be the last communication opportunity before the mobile device enters and stays in the “blind spot” for a period of time. The mobile device may determine any communication needs (e.g., based on looking ahead of the workflow and/or statistical data for executing workflows related to this blind spot). For example, the communication session may be started to determine whether there is any network communication needs in near future. A period of time until the mobile device comes out of the blind spot can be estimated (e.g., (e.g., based on log data and/or statistical analysis of log data which may be collected by the same mobile device and/or other mobile device). The estimation may be made by the mobile device, or by the server, or based on a combination of estimations made by the mobile device and the server. The mobile device may query a server to determine whether the server may need to communicate with the mobile device for the estimated period of time.

For example, the mobile device may determine whether there are data scheduled to be transmitted from the mobile device and perform the data transmission before reaching the “blind spot” when there exist such data. For example, the mobile device may check with a server to determine whether there are pending updates, data, workflow applications, service requests, instructions, etc., that are to be transmitted to the mobile device and start to download from the server if there exist such scheduled communications. For example, the mobile device may download from the server the next service request, service instruction, or dispatch workflow for a task that is scheduled to be carried out by the user of the mobile device (e.g., the workflow application for the next stop of delivery), so that the mobile device gets the next task before the current task is completed, in anticipation that the mobile device may be in the “blind spot” at the time the mobile device finishes the current task; the mobile device may download the data that may be used to carry out the current and/or the next task, such as product recall information, price adjustment information (e.g., in view of a competitor's offer), list of supply/parts needed for the next service, product details for the service. For example, the mobile device may report to the server that a customer or the deliver truck is running out of a particular type of supply. The mobile device may report that an equipment (e.g., a cooler) is broken, receive a workflow application to address the situation, and run the workflow application to work through a diagnose process, and place an order of parts needed to repair the equipment. The mobile device may report the need for transportation and require a dispatcher to make an arrangement.

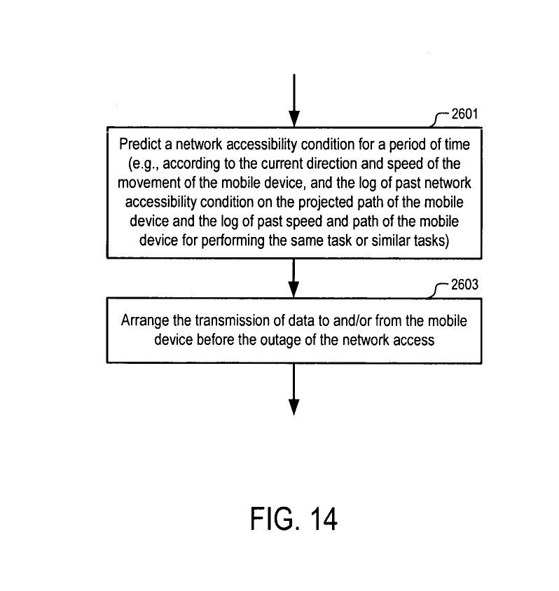

FIG. 14 shows a flow diagram of another process to improve workflows using log data. In FIG. 14, a network accessibility condition for a period of time is predicted (2601). The prediction may be made according to the current direction and speed of the movement of the mobile device, the log of past network accessibility condition on the projected path of the mobile device, and the log of past speed and path of the mobile device for performing the same task or similar tasks, etc. Based on the prediction, the transmission of data to and/or from the mobile device before the outage of the network access can be arranged (2603).

For example, the method processor may automatically increase the priority of communication tasks to allow the communication operations to be performed earlier (e.g., before the outage of network connection).

For example, the method processor may prompt the user to execute a pending workflow application which requires network connectivity in a high priority thread and decrease the priority of the workflow of the thread that may not need the network connectivity during the time period in which the mobile device is in the “blind spot.”

For example, a dispatcher may modify the workflow and transmit the updated workflow to the mobile device before the mobile device reaches the blind spots. For example, the dispatcher/controller may push applications and data to the mobile device before the mobile device reaches the “blind spot.”

For example, the mobile device may transmit data (e.g., log data, or application data such as changes to check-out version of data, etc.) to the server before the mobile device reaches the “blind spot.”

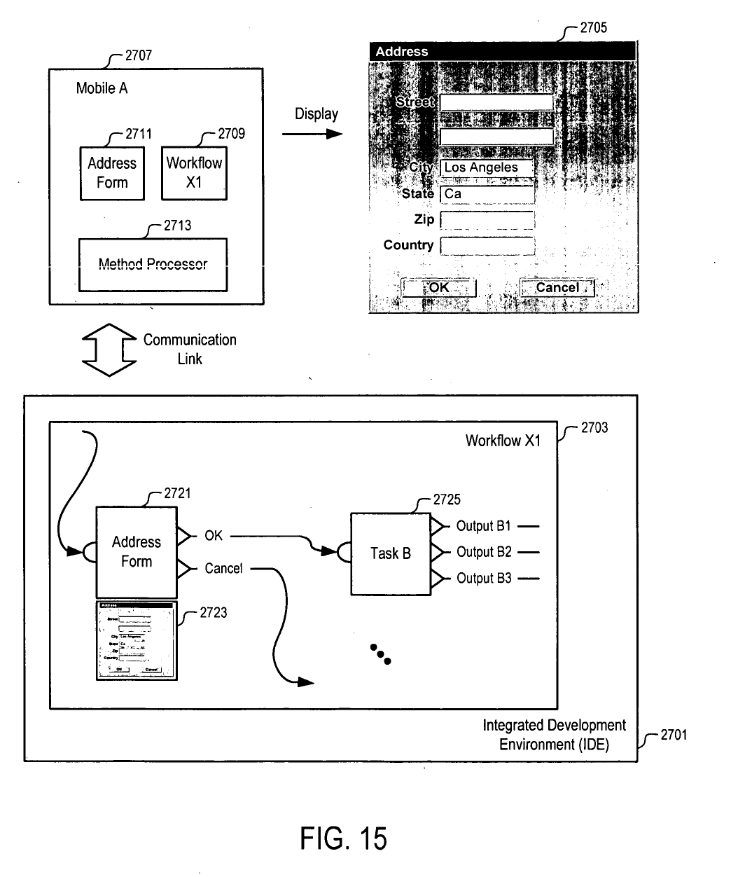

FIG. 15 illustrates an integrated development environment with a self documenting feature. In FIG. 15, a display of the integrated development environment (IDE) (2701) shows a graphical representation of a workflow (2703). The workflow (2703) specifies the direction of flow among a number of modules, such as flowing from address form (2721) to task (2725) when the output of the address form is “OK”. For example, when the “OK” button of the address form is pressed, the address form generates the outcome “OK”; when the “Cancel” button of the address from is pressed, the address from generated the outcome “Cancel”.

After the address form (2711) is loaded into the mobile device (2707) and the workflow is transmitted to the mobile device (2707), the definition of the workflow (2709) (e.g., in XML) can be loaded by the method processor (2713) for execution on the mobile device (2707). When the flow reaches the address form and the code for the address form (2711) is executed on the mobile device, a display of the address form (2705) is generated on the screen of the mobile device.

The method processor can capture the screen image of the display of the address form (2705) and transmit the captured screen image to the Integrated Development Environment (2701), which can then display a thumbnail-size version of the captured image (2723) near the iconic representation of the “address form” (2721). The captured image is reduced to a size (e.g., by the Integrated Development Environment (2701)) that is in the same order of the size of the iconic representation of the “address form” (2721) for display in the visual representation of the workflow (2703). Integrated Development Environment (2701) can also display a full-size version of the captured image (e.g., when the thumbnail-size version of the captured image is selected). Further, the Integrated Development Environment (2701) may display the captured image according to a size configurable by the user. For example, the user may specify a preferred size of the captured image, or a factor to reduce the capture image, to generate a version of the captured image for display in the visual representation of the workflow.

Alternatively, the thumbnail-size version of the captured image can be used to replace the generic icon that is used represent the address form in the visual representation of the workflow (2703) in the integrated development environment (2701) when the captured image is not available. When the captured image is available, the generic icon or the thumbnail-size version of the captured image can be selectively used according to a user preference.

In one embodiment of the present invention, when the thumbnail-size version of the captured image (2723) in the graphical representation of the workflow (2703) is selected by the user (e.g., through clicking a mouse button while the cursor is over the image, or through hovering or stopping the cursor over the image, etc.), the full version of the captured image can be displayed to show the details of the captured image. The thumbnail-size version of the captured image (2723) in the graphical representation of the workflow (2703) can also be selected to bring up a user interface to edit the source code of the corresponding task module. Different ways to select the thumbnail-size version of the captured image may cause different actions, such as displaying the full size image, opening a window for the editing of the source code, etc.

Further, the method processor may capture updated screen images as the user interacts with the address form displayed on the mobile device. The updated screen images can be transmitted to the integrated development environment so that the developer/dispatcher using the Integrated Development Environment (2701) can watch the real time activity of the workflow. The thumbnail-size version of the captured image (2723) can be updated according to the updated screen image.

Further, the Integrated Development Environment (2701) can store a set of captured screen images in a sequence as captured by the method processor and display a time line of the screen images in response to a user request.

In one embodiment of the present invention, the method processor (2713) of the mobile device (2707) can transmit the log data to the integrated development environment so that the developer/dispatcher using the Integrated Development Environment (2701) can watch and see graphically which of the task modules have been executed, which of the flow paths have been executed, which of the task modules have not yet been executed, which of the flow paths have not yet been executed, etc. Further, the Integrated Development Environment (2701) can show how many times a module or a flow path has been executed and/or an indicator of frequency of the execution of a module or a flow path. From the integrated development environment (2701), the developer/dispatcher can inspect the values of the variables (e.g., global variables of the workflow) as reported by the logger of the method processor (2713), while the workflow application is being executed on the mobile device. Thus, the integrated development environment (2701) can be used to debug and diagnose the workflow application that is running in the real world live.

For example, the dispatcher may monitor the execution of the workflow on the mobile device and provide help to the user of the mobile device when needed.

For example, the developer may monitor the execution of the workflow to fully debug the application.

For example, the trainer using the Integrated Development Environment (2701) can monitor the progress of a trainee who is using the mobile device (2707).

During the execution of the workflow, the method processor may log data to the fully extend (or at other specified data logging level) to provide log data related to the time, location, variable states, memory states and other sensor/meter data to the Integrated Development Environment (2701), which may display the log data in a structured way upon in response to a user request. Thus, the Integrated Development Environment (2701) can also be used in data mining the log data collected by the method processor (2713).

In general, the mobile device (2707) may transmit all the captured data to the Integrated Development Environment (2701) in real time, or part in real time and part in batch mode, or all in batch mode. For example, the log data may be stored in a file and loaded into the Integrated Development Environment (2701) when available for analysis.

The log data collected from one or more mobile devices may also be stored in a database, loaded into a spreadsheet for analysis, loaded into a custom tool for data mining and analysis, etc.

In one embodiment of the present invention, a pattern recognizer may monitor the output of the logger to detect pre-defined patterns on-the-fly. The occurrence of the pre-defined patterns can then generate a data logging event and/or an alert.

The features described can also be implemented in a stand alone application or other applications (e.g., as a plug-in module) which may not be an Integrated Development Environment (2701). For example, a stand alone application can be used to display a visual representation of the workflow (e.g., based on information provided in the method file), receive a real time stream of log data or a batch file of log data, display captured screen images of forms/graphical user interfaces, show the paths and modules that have been executed, display values of variables in the global variable pool, display memory status/device status of the mobile device, display meter/sensor data logged by the mobile device, etc. It is understood that it is not necessary to implement the monitoring, diagnosis, training, data mining, and other capabilities described above in an Integrated Development Environment. These can be implemented in a stand along tool, or other applications. Further, it is not necessary to implement all these capabilities in a same application. An application may include one or more of these capabilities, which may run on a mobile device, on a desktop computer or workstation, or a server computer.

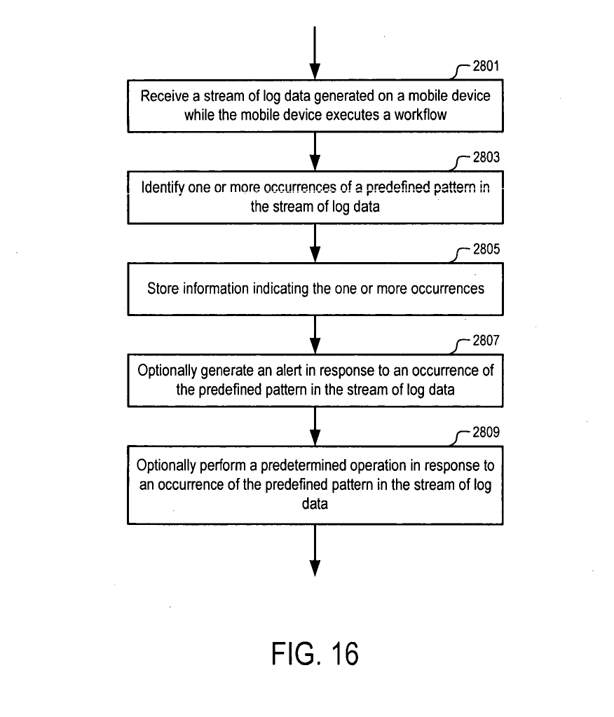

FIG. 16 shows a flow diagram of a process to utilize patterns in a stream of log data to provide a monitoring feature. In FIG. 16, after a stream of log data generated on a mobile device is received (2801) while the mobile device executes a workflow, one or more occurrences of a predefined pattern in the stream of log data are identified (2803). Information indicating the one or more occurrences is stored (2805). Optionally, an alert in response to an occurrence of the predefined pattern in the stream of log data can be generated (2807).

Optionally, the mobile device may perform (2809) a predetermined operation in response to an occurrence of the predefined pattern in the stream of log data. For example, the method processor may log the occurrence of the predefined pattern; the method processor may execute another application or module (e.g., a workflow executed in a separate thread) in response to the occurrence of the predefined pattern; and/or the method processor may alter the current execution of the workflow in response to the occurrence of the predefined pattern.

The identification of the occurrence of the predefined pattern can be performed substantially in real time on the method processor (e.g., in a background thread that monitoring the data generated by the logger). When the occurrence of the predefined pattern (e.g., a particular combination of log data items) is detected, the method processor may determine that a “signature” event happened, which may cause the logger to log additional information (e.g., time or location) and/or cause the method processor to run additional modules (e.g., in a separate thread) to provide a warning signal, to provide help information, to prompt the user to take certain action, etc.

For example, a threshold time period to perform a set of operations by a user be determined (e.g., based on statistics from log data of past execution of the operations, or based on a projected target for a group of users or an individual user). The method processor may detect a “signature” event in which the time period to perform the set of operation by the user is longer than the threshold time period. The “signature” event may cause the transmission of log data relevant to the “signature” event to a server for further analysis. The occurrences of the “signature” event can be logged and analyzed.

Further, the “signature” event may be connected with a compensation system. For example, when the user performs the set of operations in a time period less than the threshold time period, the user may be rewarded (e.g., with reward points and/or bonus pay). The “signature” event can be logged and used in a performance enhancing system and/or a reward/compensation system.

Another example of a “signature” event includes a particular execution pattern of one or more modules. For example, when a user is confused with a user interface, the user may enter a user interface form and back away from the form and try another user interface form. For example, the user may be non-product for a period of time with a user interface form, etc. Thus, a “signature” event can be defined to detect the occurrence of non-productiveness and/or confusion, which may further cause the method process to execute a help module to provide instructions to the user and/or start a training session.

Further, “signature” events may be in the determination of the performance of the design of workflow applications. For example, when many users are confused by a user interface form, the user interface form may be examined, modified, and/or re-documented to provide better training, etc.

The logger of the method processor may be directed to log information in response to events that are defined as patterns of other events/data. Events/data for the logging activity can be filtered based on the pattern recognition analyses to reduce the amount of log data to be stored/transmitted. Thus, the pattern analyzer can be used as a filter of log data. The mobile applications may be developed to selectively log data at a high level, which may increase the efficiency and usefulness of logging and reduce the memory requirement and/or the bandwidth requirement for the transmission of log data. The desired level may be specified in a number of ways, such as in the method file, in a configuration file for the mobile device, in a configuration for the application, and a combination of these. It is understood that it is not necessary to code the level in a method file.

For example, the method processor may be configured to record the time duration of a group of modules to determine how long it takes to perform a unit of work (e.g., to scan a bar code, to deliver a package, to make a phone call, to fill up a tank, to obtain a signature of a customer, etc.). Alternatively, such data mining can be performed offline on a server after the log data is collected from the mobile device (e.g., in a batch mode or in real time).

For example, the log data can be used to determine the performance of a user relative to other users, relative to a predefined goal or a user set goal. The user may be rewarded in certain ways for meeting the goals (e.g., to accumulate points which may be redeemed for vacation or be used for the evaluations for promotions). The method processor may provide feedback, suggestions, or optimization of a workflow, based on the goal. For example, when the user sets a goal to accomplish a task within a certain time limit, the method processor may, based on statistical data, determine the estimated time limits for performing the subtasks of the task and provide feedback showing a comparison between the real time performance and the estimated time limits for the subtasks. The method processor may alert the user when the user is behind the schedule. Based on the log data, the method processor may look ahead and anticipate the need to preload user interface forms, preload modules, perform communication tasks to avoid being affected by network outage, power up a radio transmitter for a scheduled communication session, etc.

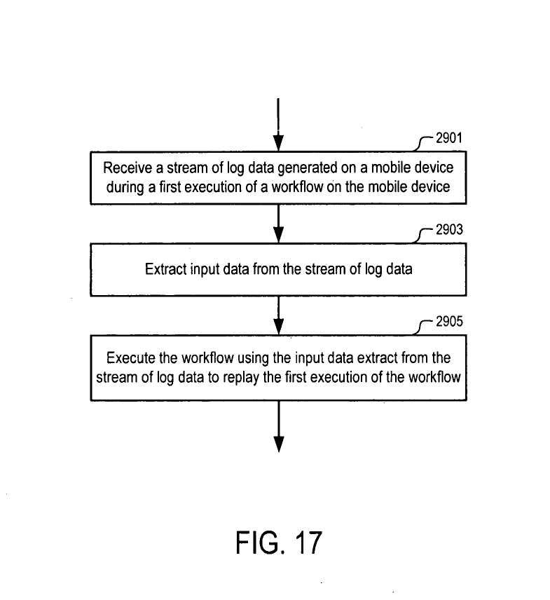

FIG. 17 shows a flow diagram of a process to replay an execution of a workflow. In FIG. 17, a stream of log data generated on a mobile device is received (2901) during a first execution of a workflow on the mobile device to extract (2903) input data from the stream of log data. The workflow can then be executed (2905) using the input data extract from the stream of log data to replay the first execution of the workflow. The capability to re-run the execution of a workflow based on the log data can be helpful in diagnosis, trouble shooting, debugging, training, etc.

Further, the recorded execution of the workflow can be used to guide further executions of workflow (e.g., by trainees). For example, the recorded log data of the execution of the workflow can be used as a standard execution path for the workflow in training sessions. When the execution path of the workflow on the mobile device of a trainee deviates the standard execution path, an alert can be generated to inform the instructor and/or the trainee. The method processor may bring the current execution back to the standard execution path, or allow the deviation to occur and continue.

For example, the method processor may run a background thread (e.g., a workflow application) on the mobile device of the trainee to compare the recorded log data of the standard execution and the log data generated from the execution by the trainee. When a deviation is detected, the method processor may alert the trainee and/or send a message to the instructor.

Alternatively, the method processor may transmit the live log data stream to the computer of the instructor. The computer of the instructor compares the live log data stream to the recorded log data of the standard execution to detect deviation, generates an alert to the instructor, and/or sends an message (e.g., as a workflow application with high priority) to the mobile device of the trainee.

In one embodiment of the present invention, a method processor may be configured to provide help information for the modules used in the workflow. For example, a help file/entry may be associated with a module (e.g., by specifying a help identifier in a tag that identifies the module in the method file that uses the module). When a “help” button on the mobile device is pressed (or other user input is received to request help) while this module is being executed, the method processor can automatically determine the help file/entry and display the corresponding help information.

Further, for example, a graphical user interface module may present a data entry form. The graphical user interface module may have a number of states, depending on the user input. For example, the keyboard focus may be at different entry boxes, depending on the user input. The help file may specify different contents for the module in different states. During a documentation run of the workflow, different states of the graphical user interface module can be identified by the method processor with corresponding captured screen images. The integrated development environment can then be used to assign different help entries to the different states of the graphical user interface module. When the “help” button is pressed, the method processor can automatically retrieve the help entry for the corresponding state of the graphical user interface module to provide the most relevant help information.

Thus, the code development of the task modules can be separate from the documentation and help system of the module.

Further, a same user interface task module used in different applications can have different help information. For example, a default help file for the module can be used when there is no application specific help information for the module. An application specific help information can be provided in addition to the default help information for the module or as a replacement to the default help information.

The help information may be specified in a configuration file (e.g., the configuration file for the module, or for the application) or specified in the method file that specifies the workflow.

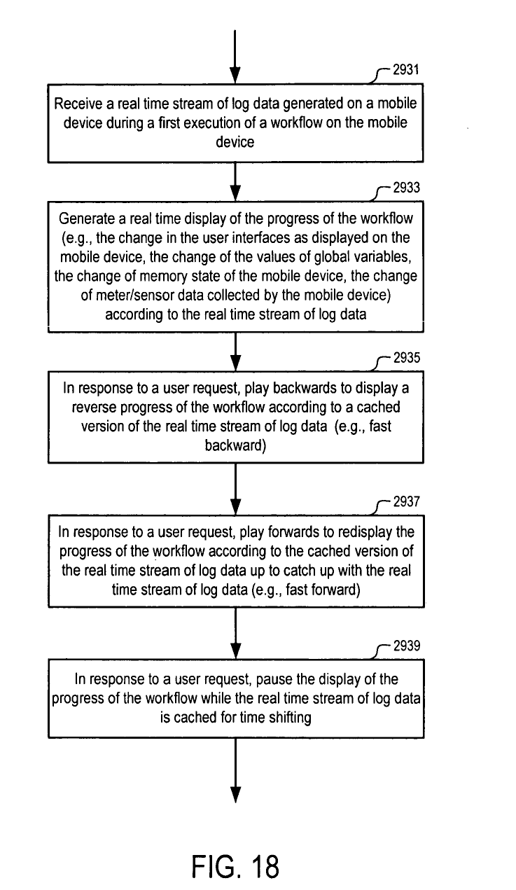

FIG. 18 shows a flow diagram of a process to display an execution of a workflow with a time shifting feature.

In FIG. 18, a real time stream of log data generated on a mobile device is received (2931) during a first execution of a workflow on the mobile device to generate (2933) a real time display of the progress of the workflow according to the real time stream of log data, such as the change in the user interfaces as displayed on the mobile device, the change of the values of global variables, the change of memory state of the mobile device, the change of meter/sensor data collected by the mobile device. The progress of the workflow may include the progress of meter/sensor data (e.g., the gas tank level, the temperature of the mobile device) in relation with the execution of the workflow.

In response to a user request, the execution of the workflow can be played (2935) backwards to display a reverse progress of the workflow according to a cached version of the real time stream of log data (e.g., fast backward).

In response to a user request, the execution of the workflow can be played (2937) forwards to redisplay the progress of the workflow according to the cached version of the real time stream of log data up to catch up with the real time stream of log data (e.g., fast forward).

In response to a user request, the display of the progress of the workflow can be paused (2939) while the real time stream of log data is cached for time shifting.

Thus, the stream of log data represents a time sequence of actions related to the workflow, which can be played in real time, paused for time shifting, played fast forward or backward, etc. Since the log data are time is stamped, the log data stream can be played at the same time scale as the stream of log data (e.g., playing at a normal speed of the data stream), or played at a different time scale (e.g., playing at a speed slower or faster than the normal speed of the data stream). Alternatively, the log data stream may be played step by step according to user control.

The display of the progress of a workflow may include display of the sequence of one or more of: graphical user interface, value of a global variable, module being executed, path from one module to the next, and measurement of a meter or sensor.

The playback of the workflow can be used to trouble shooting problems, evaluate the performance of the user, determine area of improvements, etc.

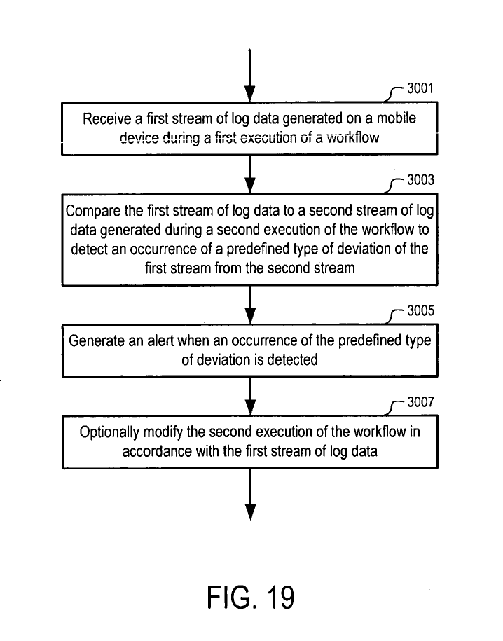

FIG. 19 shows a flow diagram of a process to monitor deviation from a reference execution of a workflow. In FIG. 19, a first stream of log data generated on a mobile device is received (3001) during a first execution of a workflow to compare the first stream of log data to a second stream of log data generated during a second execution of the workflow to detect an occurrence of a predefined type of deviation of the first stream from the second stream. An alert is generated (3005) when an occurrence of the predefined type of deviation is detected. Optionally, the second execution of the workflow can be modified (3007) in accordance with the first stream of log data.

A deviation may include one or more of: the deviation of execution path from one module to another and the deviation of data flowing into and/or out of a module.

For example, when a deviation in execution path is detected, the method processor may alert the user of the mobile device and re-execute the module that causes the deviation (e.g., in a training session). Alternatively, the user may be presented with an option to try the module again or to have the method processor to correct the execution path in accordance with the first stream of log data. Alternatively, the method processor may automatically correct the execution path after the user failed to provide the correct input a predetermined number of times (e.g., three times).

For example, the user may have selected a data option that changes a global variable to an incorrect value. The method process may re-execute the module to allow the user to select the correct data option, or alert the user about the mistake and automatically correct the global variable to the correct value to continue into the next module. Alternatively, the user may be presented with an alerting showing the mistake and an option to try the module again or to have the method processor to correct the global variable in accordance with the first stream of log data. Alternatively, the method processor may automatically correct the global variable after the user failed to provide the correct input a predetermined number of times (e.g., three times).

The method processor may selectively tolerate deviations in some global variables and force the execution in the training session to have certain values for other global values with or without alerting the user. For example, the method processor may automatically override some input values taken from the user to allow the execution in the training session to follow a prior recorded execution.

The method processor may selectively tolerate deviation in some execution paths. When the deviation is detected, the method processor may locate a corresponding location in the recorded stream of log data of the reference execution to match the current execution to a corresponding point in the reference execution and then continue the monitoring operation. The matching may be based on matching a continues execution path from one module to another, where the path may or may not include intermediate modules in between. The matching may be further based on the value of one or more global variables and/or other conditions.

In response to a deviate, the method processor may execute a help module to guide the user. For example, the help module may determine the possible source of errors and provide instructions to the user to avoid the errors (or deviation). The help module may provide information to explain the current module of the workflow. The help module may play back a recorded message or video to illustrate a way to interact with the current module of the workflow.

The method processor may record the deviation and generate statistics to assess the progress of the trainee. The mobile device of a trainee may transmit information to a system of a trainer, such as the alert of deviation, a portion of the log data generated at the mobile device in executing the workflow, and/or statistics about the progress of the trainee. Thus, the trainer may monitor the progress of multiple trainees and provide help to those who need help based on the deviation in their execution from the reference execution.

For example, the system of the trainer may display the locations of deviation in the workflow by different trainees, the different values generated in the different executions of the trainees, time durations spent by a trainee on modules that cause deviations, and others. The difficult to use modules may be identified for modification and/or for the generation of improved training instructions.

The information related to the trainee may be provided to the trainer in a real time, or in a batch mode. The help system may provide the guide and/or instructions with or without input for the trainer. For example, the help system may include the prerecorded narrative for different user interface modules. When the deviation is detected, the help system locates the relevant information for presentation to the user.

The help system may also be invoked during the execution of the workflow (e.g., through pressing a help button on the mobile device). When in the help system, the user may be offered a training session (e.g., running in a separate thread to isolate the data from the current execution of the workflow) to run a portion of the workflow in a training mode (e.g., guided by a pre-recorded stream of log data). After the user becomes familiar with the portion of the workflow, the user may end the training session and resume the original workflow.

The training module may be specific to a particular workflow application. When a new workflow application is provided to the mobile device of a user, the training module may also be provided (e.g., as a help file for the application to a generic help workflow application, or as a configuration file for the particular workflow application, or as a custom help workflow application). When the user views the list of pending applications to be executed, the mobile device may alert the user about the new workflow application and offer a training session for the user. The workflow may playback the pre-recorded execution of the workflow application (e.g., according to the log data of the workflow application). The user may run the workflow in a training mode; and the method process guides execution in the training mode based on the pre-recorded execution.

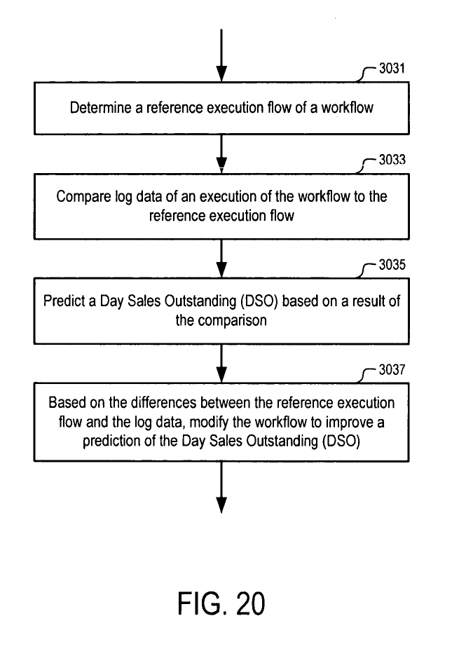

FIG. 20 shows a flow diagram of a process to perform prediction and optimization based on monitoring an execution of a workflow. In FIG. 20, after a reference execution flow of a workflow is determined (3031), the log data of an execution of the workflow is compared (3033) to the reference execution flow. A Day Sales Outstanding (DSO) is predicted (3035) based on a result of the comparison. Based on the differences between the reference execution flow and the log data, the workflow can be modified (3037) to improve a prediction of the Day Sales Outstanding (DSO). For example, when an execution sequence is determined to be more efficient to reduce the prediction of the Day Sales Outstanding (DSO), the workflow may be modified to guide further execution toward the preferred execution path. For example, the business logic of the workflow may be modified to reduce the prediction of the Day Sales Outstanding (DSO).

The log data collecting capability and the flexibility to customize mobile applications according to embodiments of the present invention can be used in many different environments.

In one example, a mobile device can be used to monitor certain behavior of the user. For instance, a mobile device may be equipped with a RFID reader, which is capable to read the RFID attached to the end caps in a grocery store. The mobile device may read the RFID as part of the log data while the mobile device is working based on a workflow near an end cap. Based on the log data, the mobile device can determine and/or monitor for how long the mobile operator stands near the end cap and servicing the end cap.

In another example, a mobile device may be operated near or in a refrigerated room at a grocery store. The refrigerated room can have a temperature sensor, which may report the current temperature, or a recorded history of temperatures for a period of time, to the mobile device (e.g., through a wireless communication connection, such as Bluetooth). The mobile device may take the data as part of the log data which can be used in further analysis. Thus, when the mobile operator enters the room, the mobile device may communicate with a device that tracks the temperature of the refrigerated room. The temperature data is downloaded to the mobile device and then either analyzed or passed on to the ERP system. Alternatively, or in combination, the mobile device may have a temperature sensor, which is used to get the temperature of the room while the mobile operator is in the room.

In a further example, the software architecture according to embodiments of the present invention allows a vendor (for example the store owner, such as Safeway) to design screens for the truck driver who delivers to Safeway. In this way the truck driver can present the mobile device to the Safeway manager or the Safeway personnel and have the Safeway personnel carryout Safeway functions (designed to the Safeway user interface and the Safeway specification) while the truck driver is at Safeway. The architecture allows Safeway to remotely and uniformly, quite easily change the experience that's going to happen in each Safeway store by changing screens or process sequences. In this way Safeway has control of the programs that are being carried out on-site by third-party truck drivers. It should be noted that not only can the vendor (e.g., Safeway) change the screen images that are presented to the operator (for the operators use or for use by the Safeway personnel) but that the bender can also change the tasks that are given on-the-fly to the mobile operator. This presents a new method of doing business in providing a service that allows the vendor to custom design the processes and the user experience that happens for delivery people or other service people coming to their sites.

In the above description, terms such as “first” and “second” may have been used to identify items or operations, such as image, form, module, stream of log data, execution of a workflow, etc. The use of such terms is intended to clearly identify items of a same type within an individual example. The use of such terms does not imply a particular time sequence relative to the operations described or implied in the individual example. For example, a “first” image may or may not be created before a “second image”; a “first” execution of a workflow may or may not have prior instances of execution of the workflow; a “second” execution of the workflow may or may not be prior to the “first” execution of the workflow; and there may or may not be other instances of execution of the workflow between the “second” execution of the workflow and the “first” execution of the workflow. Any item or operation may be identified as “first”, or “second”, or “third”, etc.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method on a mobile device, comprising:
receiving a representation of a workflow over a wireless connection at the mobile device to specify information including:
locations of codes of a plurality of tasks;
mappings between local variables of the tasks and global variables maintained by the mobile device; and
relations between outcomes of the tasks and corresponding ones of the tasks that are scheduled to be execute when corresponding outcomes are generated; and
loading and executing the codes on the mobile device according to the representation of the workflow.

2. The method of claim 1, wherein the representation of the workflow is in an Extensible Markup Language (XML).

3. The method of claim 2, wherein a code of one of the tasks is in a shared library on the mobile device.

4. A method, comprising:
executing a workflow interpreter in a process running on a virtual machine for a programming language, the interpreter to parse a workflow defining execution flow among multiple modules, at least one module of the modules being in the programming language; and
loading the module in the programming language into the process for execution according to the workflow.

5. The method of claim 4, wherein the workflow is defined in an extensible markup language (XML).

6. The method of claim 5, wherein the programming language is Java byte code or Microsoft Intermediate Language.

7. The method of claim 5, wherein the module in the programming language is compiled from code in one or more programming languages including one or more of: C, C++, C#, and Java.

8. The method of claim 4, wherein one of the modules generates a graphical user interface.

9. The method of claim 8, wherein one of the modules does not generate a graphical user interface.

10. The method of claim 4, wherein one of the modules specifies a workflow.

11. A method, comprising:
executing a workflow engine in a first thread of a process, the workflow engine to parse a workflow defining execution flow among multiple modules; and
executing a cache manager in a second thread of the process, the cache manager to manage caching of one or more modules of the multiple modules of the workflow.

12. The method of claim 11, wherein the cache manager is configurable to adjust a usage of computation resource used by the cache manager.

13. The method of claim 12, wherein the cache manage is dynamically configurable to adjust a limit on a number of modules to be cached.

14. The method of claim 12, wherein the cache manage is dynamically configurable to adjust a limit on an amount of cache memory.

15. The method of claim 11, wherein the cache manager pre-loads the one or more modules into cache based on likelihood modules to be executed after execution of a current module.

16. A method, comprising:
processing a first version of a workflow which defines first execution flow among first multiple modules;
during an execution of the workflow according to the first version of the workflow, receiving a second version of the workflow which defines second execution flow among second multiple modules, the first multiple modules and the second multiple modules having at least one common module; and
continuing the execution according to the second version of the workflow without restarting.

17. The method of claim 16, wherein said continuing the execution comprises:
executing the workflow up to the common module according to the first version of the workflow; and
executing the workflow according to second version of the workflow after an execution of the common module.

18. The method of claim 16, wherein the first execution flow is different from the second execution flow.

19. The method of claim 18, wherein the first multiple modules correspond to the second multiple modules.

20. The method of claim 18, wherein the second multiple modules include a module that is not in the first version of the workflow.

21. The method of claim 18, wherein the first multiple modules include a module that is not in the second version of the workflow.

22. A method, comprising:
processing a workflow described in a file which defines execution flow among multiple modules;
during execution of the workflow, determining a version of one module of the multiple modules; and
loading the version of the module for execution of the workflow.

23. The method of claim 22, wherein the version is a latest version of multiple versions of the module.

24. The method of claim 23, wherein the version is determined according to version number.

25. The method of claim 23, wherein the version is determined according to time of arrival of the versions at a mobile device on which the method is performed.

26. The method of claim 23, wherein the module comprises a file which defines execution flow among multiple modules; and the latest version is loaded in a cache to replace a previous version of the module during the execution of the workflow.

27. The method of claim 23, wherein the module comprises a shared library which is in a same programming language as a workflow engine which processes the workflow; and the method further comprising:
unloading a previous version of the module during execution of the workflow.

28. The method of claim 23, further comprising:
receiving the latest version of the module during execution of the workflow.

29. The method of claim 22, wherein the module is not available on a mobile device on which the method is performed when execution of the workflow is initiated.

30. A method, comprising:
executing a workflow engine to process a queue of workflows, each of the workflows defining execution flow among one or more modules;
waiting for reception of one or more workflows to be added to the queue when the queue is empty; and
receiving a user selection to start one of workflows in the queue.

31. The method of claim 30, further comprising:
automatically selecting a workflow from the queue for execution using a user request based on a priority indicator of the workflow.

32. The method of claim 30, further comprising:
removing a workflow from the queue after an execution of the workflow.

33. The method of claim 30, further comprising:
adding a workflow back to the queue after an execution of the workflow.

34. The method of claim 30, further comprising:
presenting a graphical user interface to manipulate the queue;
wherein the workflow engine processes the queue according to a workflow.

35. A method, comprising:
loading a first task module from a first vendor to execute a workflow application on a mobile device; and
loading a second task module from a second vendor to execute the workflow application on the mobile device.

36. The method of claim 35, further comprising:
generating a workflow application including the first task module from a first vendor and the second task module from the second vendor.

37. The method of claim 36, wherein the workflow application is generate without source coded access to at least one of the first task module from a first vendor and the second task module from the second vendor.

38. A method, comprising:
receiving a request to access a device of a type from a module of a workflow running on a mobile device;
determining a first device of the type currently available to the mobile device;
selecting one routine from a plurality of routines capable of operating a plurality of different devices of the type; and
executing the routine according to the request.

39. The method of claim 38, wherein the method is performed on the mobile device running a workflow engine which executes the workflow.

40. The method of claim 39, wherein said selecting is performed by a library code installed on the mobile device.

41. A method, comprising:
executing a first module by a workflow engine in a first thread; and
executing a second module by the workflow engine in a second thread concurrently with the first thread.

42. The method of claim 41, wherein the first module comprises a first workflow; and the second module comprises a second workflow.

43. The method of claim 42, wherein the first module and the second module are in a third workflow executed in the workflow engine.

44. The method of claim 43, wherein a same outcome of a module in the third workflow leads to both the first module and the second module.

45. The method of claim 43, wherein the second module follows the first module in the third workflow.

46. A method, comprising:
receiving a request to close a first form of a first module of a workflow, the workflow specifying a flow from the first module to the second module;
determining a second form of the second module of the workflow; and
rendering the second form before closing the first form.

47. The method of claim 46, further comprising:
intercepting by a workflow engine an event to close the first form;
wherein the workflow engine loads the second form before closing the first form.

48. The method of claim 47, wherein the workflow engine loads the second form in a non-modal way.

49. The method of claim 48, wherein the second form is painted before the first form is closed.

50. The method of claim 49, wherein the second form is painted above the first form before the first form is closed.

51. The method of claim 49, wherein the second form is painted under the first form before the first form is closed.

52. The method of claim 49, wherein the workflow engine loads the second form for rendering after the event to close the first form is intercepted in the workflow engine.

53. A method, comprising:
displaying help information relative to a current portion of user interface of a workflow during a first execution of the workflow; and
running a second execution of the workflow in a training mode in response to a user request during the first execution of the workflow.

54. The method of claim 53, wherein the first execution of the workflow is maintained in a first thread while the second execution of the workflow is executed in the training mode in second thread.

55. The method of claim 54, further comprising:
comparing log data of the second execution of the workflow with log data of a third execution of the workflow to determine a deviation in real time.

56. A method, comprising:
logging information related to a workflow as being processed, the workflow defining execution flow among multiple modules; and
associating the information related to the workflow with measurement information.

57. The method of claim 56, wherein the workflow is provided as input to a workflow execution engine which collects the information related to the workflow as being processed for a logger to log the information related to the workflow in association with the measurement information.

58. The method of claim 57, wherein the logger collects the measurement information from one or more peripheral devices.

59. The method of claim 56, wherein the measurement information includes time obtained from a clock.

60. The method of claim 59, wherein the measurement information further includes a space location.

61. The method of claim 60, wherein the space location is obtained from a position determination device co-located with a mobile device which performs the method.

62. The method of claim 60, wherein the measurement information further includes vehicle bus information.

63. The method of claim 60, wherein the measurement information further includes a strength of a wireless communication signal.

64. The method of claim 60, wherein the information related to the workflow and the measurement information include an indication of availability of a network resource.

65. The method of claim 64, further comprising:
estimating future availability of the network resource based at least partially on the information related to the workflow and the measurement information.

66. The method of claim 56, wherein the information related to the workflow is logged when an execution of the workflow enters or exits one module of the multiple modules.

67. The method of claim 66, wherein the information related to the workflow comprises one or more of:
a state of a memory;
a state of a microprocessor;
a value of a variable to be provided to or obtained from the module;
a name of the module;
a resource location of the module; and
a provider of the module.

68. The method of claim 56, further comprising:
transmitting the information related to the workflow with the measurement information in real time to a remote location over a network connection.

69. The method of claim 56, further comprising:
storing the information related to the workflow with the measurement information for transmission to a remote location over a network connection in a batch mode.

70. The method of claim 56, further comprising:
loading one module of the multiple modules for execution;
capturing a screen image of a graphical user interface rendered by the module;
wherein the information related to the workflow comprises the screen image.

71. A method on a mobile device, comprising:
receiving a representation of a workflow over a wireless connection at the mobile device to specify a plurality of tasks;
loading and executing the executable codes on the mobile device according to the representation of the workflow; and
during execution of the workflow, generating log data when entering or exiting individual ones of the tasks according to the workflow.

72. The method of claim 71, wherein a first one of the tasks generates a graphical user interface for user interaction.

73. The method of claim 72, further comprising:
capturing a screen image of the graphical user interface as part of the log data when the first one of the tasks is executed.

74. The method of claim 73, further comprising:
transmitting the log data in real time over a network connection to an integrated development environment not running on the mobile device.

75. A method, comprising:
receiving a threshold level indicator;
determining a level identifier of a module of a workflow, the workflow defining execution flow among multiple modules;
determining whether or not to log information related to execution of the module based on a comparison between the threshold level indicator and the level identifier of the module.

76. The method of claim 75, further comprising:
determining a set of data items to be logged for the module according to a configuration file.

77. The method of claim 75, wherein the threshold level indicator specifies a set of level identifiers which when associated with a module causes the module to be logged.

78. The method of claim 75, wherein the workflow is specified in an extensible markup language (XML); and the level identifier is specified as an attribute or an element designed to specify the module.

79. The method of claim 78, wherein the threshold level indicator is specified in one of:
a configuration file for a mobile device on which the method is performed;
a configuration file specific for the workflow;
a definition of the workflow in extensible markup language (XML).

80. A method, comprising:
receiving a stream of log data of an execution of a workflow from a mobile device, the workflow defining execution flow among multiple modules; and
re-producing the execution of the workflow on a system different from the mobile device according to the stream of log data.

81. The method of claim 80, wherein the stream of log data is received by the system from the mobile device in real time; and the execution of the workflow is re-produced on the system in real time.

82. The method of claim 81, further comprising:
indicating portions of the workflow that has not been executed on a graphical representation of the workflow.

83. The method of claim 81, further comprising:
indicating portions of the workflow that has been executed on a graphical representation of the workflow; and
providing access to the stream of log data from the graphical representation of the workflow.

84. The method of claim 80, wherein said re-producing comprises:
extracting input to the multiple modules from the stream of log data;
following an execution path of the workflow according to the stream of log data; and
providing input to the multiple modules according to the input extracted from the stream of log data.

85. A method in a computing device, comprising:
receiving a first stream of log data of a first execution of a workflow, the workflow defining execution flow among multiple modules;
comparing the first stream of log data of the first execution of the workflow with log data of a second execution of the workflow during the execution of the second execution; and
determining a deviation between the first execution of the workflow and the second execution of the workflow.

86. The method of claim 85, further comprising:
generating an alert in response to a detection of a deviation in execution path between the first execution of the workflow and the second execution of the workflow.

87. The method of claim 86, further comprising:
correcting an execution path of the second execution of the workflow in accordance with an execution path of the first execution of the workflow.

88. The method of claim 87, wherein the second execution of the workflow is in a workflow engine; and the workflow engine determines the deviation and corrects the execution path of the second execution of the workflow in accordance with the execution path of the first execution of the workflow.

89. The method of claim 87, further comprising:
receiving the second stream of log data of the second execution of the workflow in real time from a mobile device during the execution of the second execution on the mobile device; and
transmitting the alert to the mobile device to correct the execution path of the second execution of the workflow in accordance with an execution path of the first execution of the workflow.

90. The method of claim 85, further comprising:
generating an alert in response to a detection of a deviation in data between the first execution of the workflow and the second execution of the workflow; and
correcting data of the second execution of the workflow in accordance with data of the first execution of the workflow.

91. The method of claim 85, further comprising:
counting a number of times that the second execution fails to to be consistent with the first stream of log data; and
automatically correcting the second execution in accordance with the first stream of log data in response to the number of times reaching a threshold value.

92. The method of claim 85, further comprising:
searching the first stream of log data to find an execution point in the first execution of the workflow matching to a current execution point in the second execution of the workflow.

93. The method of claim 92, wherein a criterion to find an execution point in the first execution of the workflow matching to the current execution point in the second execution of the workflow includes one or more of: a value of a variable and a path of one or more modules leading to a module currently being executed in the second execution of the workflow.

94. The method of claim 85, further comprising:
providing help to a user of the device to interactive with a user interface of the workflow.

95. The method of claim 85, wherein said providing help comprises:
executing a help module in response to the deviation.

96. The method of claim 95, further comprising:
logging information indicating the deviation between the first execution of the workflow and the second execution of the workflow

97. A method, comprising:
executing a workflow in a workflow engine, the workflow defining execution flow among multiple modules including at least one user interface module which when executed presents a graphical user interface;
loading the user interface module by the workflow engine for execution to generate the graphical user interface; and
capturing a screen image of the graphical user interface by the workflow engine to document the user interface module.

98. The method of claim 97, further comprising:
transmitting the screen image of the graphical user interface in real time to a location away from a mobile device on which the method is performed.

99. The method of claim 97, further comprising:
storing the screen image of the graphical user interface with log data of an execution of the workflow on a mobile device on which the method is performed;
transmitting the screen image and the log data in a batch mode from the mobile device.

100. The method of claim 97, further comprising:
the workflow engine running through the workflow without user interaction with the graphical user interface.

101. The method of claim 100, further comprising:
the workflow engine executing the workflow engine automatically to capture screen images of user interface modules of the workflow.

102. A method, comprising:
displaying a graphical representation of a workflow; and
displaying a version of a screen image of a graphical user interface generated by a module of the workflow in the graphical representation of the workflow.

103. The method of claim 102, further comprising:
reducing a size of the screen image to generate the version of the screen image.

104. The method of claim 102, wherein the version of the screen image is displayed near an iconic representation of the module in the graphical representation of the workflow.

105. The method of claim 104, further comprising:
in response to a user selection of the version of the screen image, displaying a full version of the screen image.

106. The method of claim 102, wherein the version of the screen image displayed as an iconic representation of the module in the graphical representation of the workflow.

107. The method of claim 106, further comprising:
in response to a user selection of the version of the screen image, displaying a graphical user interface to edit the module.

108. The method of claim 106, further comprising:
in response to a user selection of an icon representation of a further module of the workflow, displaying a graphical user interface to edit the further module which when executed does not display a graphical user interface.

109. The method of claim 102, further comprising:
receiving the screen image in real time from a remote mobile device which executes the workflow.

110. The method of claim 109, further comprising:
receiving an update version of the screen image of the graphical user interface when a screen image of the graphical user interface on the remote mobile device is changed.

111. The method of claim 110, further comprising:
receiving a stream of log data of execution of the workflow on the mobile device;
presenting the log data in an integrated environment in which the graphical representation of the workflow is displayed.

112. The method of claim 111, wherein the stream of log data is received in the integrated environment in real time.

113. A method, comprising:
receiving a stream of log data of execution of a workflow; and
identifying an occurrence of a predefined pattern in the stream of log data.

114. The method of claim 113, wherein said identifying is performed during the execution of the workflow.

115. The method of claim 114, further comprising:
logging the occurrence of the predefined pattern.

116. The method of claim 115, further comprising:
generating an alerting in response to a detection of the occurrence of the predefined pattern.

117. The method of claim 116, wherein the predefined pattern comprises a combination of a plurality of log data items.

118. The method of claim 116, further comprising:
logging the occurrence of the predefined pattern.

119. The method of claim 116, further comprising:
executing a workflow in response to the occurrence of the predefined pattern.

120. A method, comprising:
determining a reference execution flow of a workflow;
comparing a first execution flow of the workflow to the reference execution flow based on log data generated for the first execution flow;
predicting an indication of a performance goal based on a result of the comparison.

121. The method of claim 120, wherein the performance goal comprises day sales outstanding (DSO).

122. The method of claim 120, further comprising:
modifying an execution of the workflow to improve a prediction of performance goal.

123. The method of claim 122, wherein said modifying comprises:
modifying the workflow to guide an execution flow of the workflow towards a preferred execution flow.

124. The method of claim 120, wherein said modifying comprises:
modifying business logic of the workflow to improve a prediction of the day sales outstanding (DSO).

125. The method of claim 120, wherein said comparing and predicting are performed in real time on a mobile device on which the first execution flow is generated.

126. A method, comprising:
generating a network connectivity map from log data of execution of one or more workflows on one or more mobile devices; and
updating a workflow according to the network connectivity map.

127. The method of claim 126, further comprising:
predicting availability of network connectivity based at least partially on the network connectivity map; and
wherein said updating is at least partially based on the availability predicated.

128. The method of claim 127, wherein the availability is predicted based further on a measurement of a location and a speed of movement of a mobile device on which the method is performed.

129. The method of claim 128, wherein the availability is predicted based further on history of execution of the workflow on the mobile device.

130. The method of claim 126, further comprising:
increasing a priority of a communication operation when outage of network connection is predicted.

131. A method on a mobile device, comprising:
determining a first cost to transmit first data over a first network connection;
determining a second cost to transmit the first data over a second network connection;
determining a third cost to transmit second data over the first network connection;
determining a fourth cost to transmit the second data over the second network connection; and
scheduling transmission of the first and second data based on the first, second, third and fourth costs.

132. The method of claim 131, wherein one of the first and second network connection comprises:
a connection in accordance with IEEE 802.15;
a connection in accordance with IEEE 802.11; and
a connection in accordance with IEEE 802.16.

133. A machine readable media embodying instructions, the instructions causing a mobile device to perform a method, the method comprising:
receiving a representation of a workflow over a wireless connection at the mobile device to specify information including:
locations of codes of a plurality of tasks;
mappings between local variables of the tasks and global variables maintained by the mobile device; and
relations between outcomes of the tasks and corresponding ones of the tasks that are scheduled to be execute when corresponding outcomes are generated; and
loading and executing the codes on the mobile device according to the representation of the workflow.

134. The media of claim 133, wherein the method further comprises:
executing a workflow interpreter in a process running on a virtual machine for a programming language, the interpreter to parse the workflow defining execution flow among multiple modules, at least one module of the modules being in the programming language; and
loading the module in the programming language into the process for execution according to the workflow.

135. The media of claim 133, wherein the method further comprises:
executing a workflow engine in a first thread of a process, the workflow engine to parse a workflow defining execution flow among multiple modules; and
executing a cache manager in a second thread of the process, the cache manager to manage caching of one or more modules of the multiple modules of the workflow.

136. The media of claim 133, wherein the method further comprises:
processing a first version of the workflow which defines first execution flow among first multiple modules;
during an execution of the workflow according to the first version of the workflow, receiving a second version of the workflow which defines second execution flow among second multiple modules, the first multiple modules and the second multiple modules having at least one common module; and
continuing the execution according to the second version of the workflow without restarting.

137. The media of claim 133, wherein the method further comprises:
processing a workflow described in a file which defines execution flow among multiple modules;
during execution of the workflow, determining a version of one module of the multiple modules; and
loading the version of the module for execution of the workflow.

138. The media of claim 133, wherein the method further comprises:
executing a workflow engine to process a queue of workflows, each of the workflows defining execution flow among one or more modules;
waiting for reception of one or more workflows to be added to the queue when the queue is empty; and
receiving a user selection to start one of workflows in the queue.

139. The media of claim 133, wherein the method further comprises:
loading a first task module from a first vendor to execute a workflow application on a mobile device; and
loading a second task module from a second vendor to execute the workflow application on the mobile device.

140. The media of claim 133, wherein the method further comprises:
receiving a stream of log data of an execution of the workflow from a mobile device; and
re-producing the execution of the workflow according to the stream of log data.

141. The media of claim 133, wherein the method further comprises:
displaying help information relative to a current portion of user interface of the workflow during a first execution of the workflow; and
running a second execution of the workflow in a training mode in response to a user request during the first execution of the workflow.

142. A machine readable media embodying instructions, the instructions causing a mobile device to perform a method, the method comprising:
receiving a request to close a first form of a first module of a workflow, the workflow specifying a flow from the first module to the second module;
determining a second form of the second module of the workflow; and
rendering the second form before closing the first form.

143. A machine readable media embodying instructions, the instructions causing a mobile device to perform a method, the method comprising:
logging information related to a workflow as being processed, the workflow defining execution flow among multiple modules; and
associating the information related to the workflow with measurement information.

144. The media of claim 143, wherein said logging comprises generating log data when entering or exiting individual ones of tasks of the workflow.

145. The media of claim 143, wherein the method further comprises:
receiving a threshold level indicator;
determining a level identifier of a module of the workflow;
determining whether or not to log information related to execution of the module based on a comparison between the threshold level indicator and the level identifier of the module.

146. The media of claim 143, wherein the method further comprises:
receiving a first stream of log data of a first execution of the workflow;
comparing the first stream of log data of the first execution of the workflow with log data of a second execution of the workflow during the execution of the second execution; and
determining a deviation between the first execution of the workflow and the second execution of the workflow.

147. The media of claim 143, wherein the method further comprises:
identifying an occurrence of a predefined pattern, during the execution of the workflow, using the information related to the workflow and the measurement information.

148. A mobile handheld device, comprising:
a wireless communication unit to receive a representation of a workflow over a wireless connection at the mobile device to specify information including:
locations of codes of a plurality of tasks;
mappings between local variables of the tasks and global variables maintained by the mobile device; and
relations between outcomes of the tasks and corresponding ones of the tasks that are scheduled to be execute when corresponding outcomes are generated; and
a processor coupled to the wireless communication unit to load and execute the codes on the mobile device according to the representation of the workflow;
wherein the processor is to execute the workflow in one thread of a process and executes a cache manager in a second thread of the process to manage caching of one or more modules of the workflow;
wherein the processor is to log information related to the workflow as being processed and associate the information related to the workflow with measurement information.

149. The mobile device of claim 148, wherein the processor is further to:
trap a request to close a first form of a first module of the workflow;
determine a second form of the second module of the workflow; and
rendering the second form before closing the first form.
wherein the workflow specifies a flow from the first module to the second module.

150. A system, comprising:
a dispatch station to generate and customize a workflow, the workflow to defining execution flow among multiple modules;
a population of mobile devices;
an integration server coupled to the dispatch station, the integration server to transmit a version of the workflow to one of the mobile devices via a wireless connection;
wherein the workflow specifies:
locations of codes of a plurality of tasks;
mappings between local variables of the tasks and global variables maintained by the mobile device; and
relations between outcomes of the tasks and corresponding ones of the tasks that are scheduled to be execute when corresponding outcomes are generated.

151. A machine readable media embodying instructions, the instructions causing a mobile device to perform a method, the method comprising:
defining a set of global variables maintained by the mobile device;
locating of codes of a plurality of tasks;
mapping between local variables of the tasks and the global variables; and
loading and executing the codes on the mobile device according to relations between outcomes of the tasks and corresponding ones of the tasks that are scheduled to be execute when corresponding outcomes are generated.

152. A machine readable media embodying instructions, the instructions causing a mobile device to perform a method, the method comprising:
processing log data comprising: information related to a workflow generated during execution of the workflow, and measurement information associated with the information related to the workflow;
wherein the measurement information is obtained while the information related to a workflow is generated.

153. The media of claim 152, wherein said processing log data comprises: determining a time duration of an event.

154. The media of claim 152, wherein said processing log data comprises: determining location information of an event.

155. A machine readable media embodying data generated from execution instructions, the instructions causing a mobile device to perform a method, the method comprising:
logging information related to a workflow as being processed, the workflow defining execution flow among multiple modules; and
associating the information related to the workflow with measurement information.

156. A method of providing training to users of mobile devices, the method comprising:
recording a first execution path of a workflow;
receiving log data streams generated from the users of the mobile devices running the workflow;
monitoring executions of the workflow by the users on the mobile devices based on the log data streams; and
providing help to one user of the users based on said monitoring.

157. The method of claim 156, wherein said providing comprises:
providing a new version of the workflow with a help module to the user to replace a current version of the workflow being executed on a mobile device of the user.

158. The method of claim 157, further comprising:
dynamically generating the new version of the workflow based on said monitoring.

159. A method of incentivizing an operator of a mobile device, the method comprising:
providing one or more rules to the mobile device for an incentive program;
monitoring actual performance of the operator of the mobile device during execution of a workflow;
providing to the user of the mobile device with real-time status based on said monitoring to determine performance according to the one or more rules.

160. The method of claim 159, further comprising:
allowing the mobile operator to customize a goal of the mobile operator;
tracking performance of the mobile operator in relation with the goal.

161. The method of claim 160, further comprising:
hot swapping at least one component of the one or more rules applying to the incentive program for the mobile operator.

162. A method to provide services to vendors, the method comprising:
providing the vendors with means to develop customization of workflows; and
loading the customization of workflows into mobile devices of mobile device operators when the mobile device operators visit sites of the vendors.

163. The method of claim 162, wherein the customization of workflows comprises customization of user interfaces.

164. The method of claim 162, wherein the customization of workflows comprises customized flow paths.

165. The method of claim 162, further comprising:
receiving the customization of workflows when the mobile device operators visit sites of the vendors.

166. The method of claim 162, further comprising:
providing log data from the mobile devices to the vendors when the mobile device operators visit sites of the vendors.

167. The method of claim 166, further comprising:
retrieving data from the vendors as part of log data related to execution of the workflow.
